(19) United States
(12) Patent Application Publication
(10) Pub. No.: US 2013/0181948 A1
(43) Pub. Date: Jul. 18, 2013

(54) INFORMATION PROCESSING APPARATUS AND INFORMATION PROCESSING METHOD AND COMPUTER PROGRAM

(71) Applicant: Sony Corporation, Tokyo (JP)

(72) Inventor: Yusuke Sakai, Kanagawa (JP)

(73) Assignee: SONY CORPORATION, Tokyo (JP)

(21) Appl. No.: 13/734,039

(22) Filed: Jan. 4, 2013

(30) Foreign Application Priority Data
Jan. 13, 2012 (JP) 2012-005504

(51) Int. Cl. G06F 3/042

(52) U.S. Cl. CPC G06F 3/0425
USPC 345/175

(57) ABSTRACT

Disclosed herein is intended to simultaneously display video content obtained from two or more sources. In displaying video content obtained from two or more sources in parallel to each other or as superimposed on each other, an information processing apparatus normalizes each image by use of the information such as the scale of each image and the corresponding area thereof. In the normalization, image manipulation such as digital zooming for example is executed on digital images such as a still image and a moving image. If one of the images to be displayed in parallel to each other or as superimposed on each other is an image taken with a camera block, optical control such as panning, tilting, or zooming is executed on an actual camera.

### BACKGROUND

The present disclosure relates to an information processing apparatus having a display screen also functioning as an input block based on a touch panel for example, an information processing method for the apparatus, and a computer program. More particularly, the present disclosure relates to an information processing apparatus, an information processing method, and a computer program which are configured to allow two or more users to execute an coordinated operation through a touch panel having a large screen for shared use by these users.

Recently, tablet terminals each having a display screen also functioning as an input block based on a touch panel for example have been quickly popularized. Tablet terminals have an interface based on widget and desktop and therefore easy for users to visually understand an operation method, so that users are able to use tablet terminals more easily than personal computers that require users to do input operations through a keyboard and a mouse for example.

For example, a touch sensitive device was proposed in which data belonging to a touch input associated with a multipoint sensing device is read from this multipoint sensing device like a multipoint touch screen, thereby identifying multipoint gesture on the basis of the data supplied from the multipoint sensing device (refer to Japanese Patent Laid-open No. 2010-170573 for example).

Generally, many objects to be operated by the user are arranged in various directions on the screen of a tablet terminal. Each individual object is reproduction content such as a moving image or a still image, or a mail message or a message received from another user. In order to display a desired object in the direction opposite to the user, the user is required to individually rotate the tablet terminal itself. For example, it is easy for the user to rotate a tablet terminal of A4 or A5 size. However, with a tablet terminal having a large-size screen of about twenty or thirty inches, it is cumbersome for a single user to rotate such a tablet terminal every time the user operates a desired object.

It is also considered to allow two or more users to individually operate different objects at the same time on a tablet terminal having a large-size screen.

For example, a tablet terminal was proposed in which, when a position at which a user is located on a side rim of the terminal through a proximity sensor, an area between the right hand and the left hand of the user is identified to map the identified area onto a touch point area of this user (refer to http://www.autodeskresearch.com/publications/medusa (as of Dec. 15, 2011), for example). When two or more users have been detected, the tablet terminal may be configured to allow the setting of individual user's privilege of operation for each object to be operated by the user, or prevent a user from operating the tablet terminal such as rotating an object being operated another user in the direction opposite to the former user, for example, by disabling additional user participation in advance.

However, in the usage form in which a tablet terminal having a large screen is shared by two or more users, it is assumed that the users exchange objects to execute a coordinated task, in addition to each user's individual operation of objects. It is difficult to achieve a coordinated task if a touch point area occupied by each user is set and each user executes the operation of an object given with an operation privilege inside this area.

Further, if GUI (Graphical User Interface) displayed on the screen of a terminal is constant regardless of the distance from a user or a user state for example, there occur problems such as that the information displayed on the screen is too fine for the user fairly separated from the screen to comprehend or, although the user is near enough to the screen, the amount of information displayed on the screen is small, for example. Likewise, if the input means with which the user operates the terminal is constant regardless of the distance from the user to the screen or a user state for example, there occur inconveniences such as that the user cannot operate the terminal because there is no remote controller or the user is required to reach the terminal in order to operate the touch panel.

Related-art object display systems display an image of a real object onto the screen without considering the real size information about this object. Consequently, a problem occurs that the size of an object to be displayed in accordance with the screen size and resolution (dpt) fluctuates.

In addition, in related-art display systems, displaying two or more items of video content of two or more sources in parallel or as superimposed onto the screen at the same time may result in an image difficult for the user to see if the size relation between the images displayed at the same time is not correctly displayed, resulting in the varied sizes and positions of the image areas.

Further, changing the screen direction in a terminal having a rotation mechanism makes it difficult for the user to see the display, so that the display screen must be rotated for the optimum view for the user.

### SUMMARY

Therefore, it is desired to provide an information processing apparatus, and information processing method, and a computer program, which are configured to suitably allow two or more users to execute coordinated operation through a touch panel having a large screen for shared use by these users.

In addition, it is desired to provide an information processing apparatus, and information processing method, and a computer program, which are configured to be always convenience for users to operate regardless of user position and user state.

Further, it is desired to provide an information processing apparatus, and information processing method, and a computer program, which are configured to display the image of each object always in a suitable size on the screen regardless of the size of each real object and the screen size and resolution.

Still further, it is desired to provide an information processing apparatus, and information processing method, and a computer program, which are configured to suitably display two or more items of video content obtained from two or more sources on the screen in parallel or as superimposed.

Yet further, it is desired to provide an information processing apparatus, and information processing method, and a computer program, which are configured to optimally adjust the display form of video content at a given rotational angle or in transition process when rotating the main body.

In carrying out the technology and according to one embodiment thereof, there is provided an information processing apparatus. This information processing apparatus has a camera block; a display block; and a computation section configured to normalize a user image taken with the camera block when the user image is to be displayed on a screen of the display block.

The above-mentioned information processing apparatus further includes an object image capture block configured to capture an object image to be displayed on the screen of the display block; and a parallel and superimposition pattern capture block configured to capture a parallel and superimposition pattern for putting the user image and the object image into one of parallel arrangement and superimposed arrangement on the screen of the display block. In this configuration, the computation section normalizes the user image and the object image such that a size relation between and positions of the user image and the object image become correct, thereby putting the normalized user image and the normalized object image into one of the parallel arrangement and the superimposed arrangement in accordance with the captured parallel and superimposition pattern.

In the above-mentioned information processing apparatus, the computation section controls the camera block in order to normalize the user image taken with the camera block.

The above-mentioned information processing apparatus still further includes a user face data capture block configured to capture a user face data taken with the camera block; and a face-in-object data capture block configured to capture face data in an object to be displayed on the screen of the display block. In this configuration, the computation section normalizes the user face data and the face-in-object data such that a size relation between and positions of the user face data and the face-in-object data become correct.

In the above-mentioned information processing apparatus, the computation section controls the camera block in order to normalize the user image taken with the camera block.

In carrying out the technology and according to another embodiment thereof, there is provided an information processing method. This information processing method includes: capturing an object image to be displayed on a screen of a display block; capturing a parallel and superimposition pattern for putting a user image taken with a camera block and the object image into one of parallel arrangement and superimposed arrangement on the screen of the display block; normalizing the user image and the object image such that a size relation between and positions of the user image and the object image become correct; and putting the normalized user image and the normalized object image into one of parallel arrangement and superimposed arrangement in accordance with the captured parallel and superimposition pattern.

In carrying out the technology and according to still another embodiment thereof, there is provided an information processing method. This information processing method includes: capturing face data of a user taken with a camera block; capturing face-in-object data to be displayed on a screen; and normalizing the user face data and the face-in-object data such that a size relation between and positions of the user face data and the face-in-object data become correct.

In carrying out the technology and according to yet another embodiment thereof, there is provided a computer program written in a computer-readable language to make a computer function as: a camera block; a display block; and a computation section configured to normalize a user image taken with the camera block when the user image is to be displayed on a screen of the display block.

The above-mentioned computer program defines a computer program written in a computer-readable language in order to realize predetermined processing on a computer. In other words, installing the above-mentioned computer program on a computer realizes a collaborative operation on the computer to provide substantially similar functional effects to the above-mentioned information processing apparatus.

According to the embodiments of the present technology disclosed herein, an excellent information processing apparatus, an information processing method, and a computer program that are configured to allow two or more users to suitably execute collaborative work through a touch panel on a screen shared by the users.

In addition, according to the embodiments of the present technology disclosed herein, an excellent information processing apparatus, an information processing method, and a computer program are provided that are configured to optimize display GUI and input means in accordance with user position and user state, thereby significantly enhancing user convenience.

Further, according to the embodiments of the present technology disclosed herein, an excellent information processing apparatus, an information processing method, and a computer program are provided that are configured to display an object image always with an optimum size on the screen without depending on the size of a real object and the size and resolution of a real screen.

Still further, according to the embodiments of the present technology disclosed herein, an excellent information processing apparatus, an information processing method, and a computer program are provided that are configured to normalize, when simultaneously displaying video content obtained from two or more sources on the screen in parallel to each other or as superimposed on each other, images such that the sizes and positions of corresponding area of the images are well aligned, thereby presenting an easy-to-view screen for users.

Yet further, according to the embodiments of the present technology disclosed herein, an excellent information processing apparatus, an information processing method, and a computer program are provided that are configured to optimally adjust a video content display form at any given rotational angle and in the transition process of rotating when the information processing apparatus main body is rotated.

Other features and advantages of the embodiments of the present technology will become apparent from the following description of embodiments with reference to the accompanying drawings.

### BRIEF DESCRIPTION OF THE DRAWINGS

FIG. 1 is a schematic diagram illustrating an exemplary usage form (wall) of an information processing apparatus having a large-size screen;

FIG. 2 is a schematic diagram illustrating another exemplary usage form (tabletop) of the information processing apparatus;

FIG. 3A is a schematic diagram illustrating still another exemplary usage form of the information processing apparatus;

FIG. 3B is a schematic diagram illustrating yet another exemplary usage form of the information processing apparatus;

FIG. 3C is a schematic diagram illustrating a separate exemplary usage form of the information processing apparatus;

FIG. 4 is a schematic diagram illustrating an exemplary functional configuration of the information processing apparatus;

FIG. 5 is a schematic diagram illustrating an exemplary internal configuration of an input interface section;

FIG. 6 is a schematic diagram illustrating an exemplary external configuration of an output interface section;

FIG. 7 is a block diagram illustrating an exemplary internal configuration in which a computation section executes the processing of an operated object;

FIG. 8 is a schematic diagram illustrating an exemplary appearance in which a user occupied area is set on the screen;

FIG. 9A is a schematic diagram illustrating a manner in which operated object #1 through #6 are randomly directed before user occupied area A is set;

FIG. 9B is a schematic diagram illustrating a manner in which operated object #1 through #6 are directed opposite to user A when user occupied area A of user A is set;

FIG. 10 is a schematic diagram illustrating a manner in which user occupied area B of user B and a common area are additionally set upon detection of user B in addition to user A;

FIG. 11 is a schematic diagram illustrating a manner in which user occupied area D of user D and a common area are additionally set upon detection of user D in addition to user A and user B;

FIG. 12 is a schematic diagram illustrating a manner in which user occupied area C of user C and a common area are additionally set upon detection of user C in addition to user A, user B, and user D;

FIG. 13A is a schematic diagram illustrating an area partitioning pattern for partitioning a screen into user occupied areas in accordance with the shape and size of the screen and the number of the users;

FIG. 13B is a schematic diagram illustrating another area partitioning pattern for partitioning a screen into user occupied areas in accordance with the shape and size of the screen and the number of the users;

FIG. 13C is a schematic diagram illustrating still another area partitioning pattern for partitioning a screen into user occupied areas in accordance with the shape and size of the screen and the number of the users;

FIG. 13D is a schematic diagram illustrating yet another area partitioning pattern for partitioning a screen into user occupied areas in accordance with the shape and size of the screen and the number of the users;

FIG. 13E is a schematic diagram illustrating a different area partitioning pattern for partitioning a screen into user occupied areas in accordance with the shape and size of the screen and the number of the users;

FIG. 14 is a flowchart indicative of a procedure of monitor area partitioning processing to be executed by a monitor area partitioning block;

FIG. 15 is a schematic diagram illustrating a manner in which operated objects are automatically rotated in the direction opposite to the user by moving these operated objects to the user occupied area by dragging or throwing these operated objects;

FIG. 16 is a schematic diagram illustrating a manner in which operated objects in a newly emerged user occupied area are automatically rotated in the direction opposite to the user;

FIG. 17 is a flowchart indicative of a procedure of object optimization processing to be executed by an object optimization processing block;

FIG. 18 is a schematic diagram illustrating a manner in which rotational directions are controlled in accordance with a position at which the user touches an operated object;

FIG. 19 is a schematic diagram illustrating another manner in which rotational directions are controlled in accordance with a position at which the user touches an operated object;

FIG. 20 is a schematic diagram illustrating an exemplary interaction for transferring operated objects between the information processing apparatus and a user's own terminal;

FIG. 21 is a flowchart indicative of a procedure of device-coordinated data transmit/receive processing to be executed by a device-coordinated data transmit/receive block 730;

FIG. 22 is a schematic diagram illustrating a manner in which an operated object is copied by moving the operated object between user occupied areas;

FIG. 23 is a block diagram illustrating an exemplary internal configuration in which a computation section executes optimization processing in accordance with user distance;

FIG. 24A is a table of GUI display optimization processing in accordance with user position and user state to be executed by a display GUI optimization block;

FIG. 24B is a diagram illustrating a screen transition of the information processing apparatus in accordance with user position and user state;

FIG. 24C is a diagram illustrating another screen transition of the information processing apparatus in accordance with user position and user state;

FIG. 24D is a diagram illustrating still another screen transition of the information processing apparatus in accordance with user position and user state;

FIG. 24E is a diagram illustrating yet another screen transition of the information processing apparatus in accordance with user position and user state;

FIG. 25A is a schematic diagram illustrating a screen display example in which various operated objects are randomly displayed for auto zapping;

FIG. 25B is a schematic diagram illustrating a screen display example in which positions and sizes of two or more operated objects to be automatically zapped are changed from time to time;

FIG. 26 is a schematic diagram illustrating a screen display example in which the user is viewing a television program but not operating the television;

FIG. 27A is a schematic diagram illustrating a screen display example in which the user is operating the television;

FIG. 27B is another schematic diagram illustrating a screen display example in which the user is operating the television;

FIG. 28 is a table showing input means optimization processing to be executed by an input means optimization processing in accordance with user position and user state;

FIG. 29 is a table showing distance detection scheme switching processing to be executed by a distance detection scheme switching block in accordance with user position;

FIG. 30 is a schematic diagram illustrating problems of a related-art object display system;

FIG. 31 is a schematic diagram illustrating problems of the related-art object display system;

FIG. 32 is a block diagram illustrating an exemplary internal configuration in order for the computation section 120 to execute object real size display processing in accordance with monitor performance;

FIG. 33 is a schematic diagram illustrating an example in which images of a same object are displayed in real size on the screens having different monitor specifications;

FIG. 34 is a schematic diagram illustrating an example in which images of two objects having different real sizes are displayed on a same screen while maintaining the relation of sizes of these objects;

FIG. 35 is a schematic diagram illustrating an example in which an object image is displayed in real size;

FIG. 36 is a schematic diagram illustrating an example in which an object image displayed in real size is rotated or converted in posture;

FIG. 37A is a schematic diagram illustrating an example in which real size information of a subject of imaging is estimated;

FIG. 37B is a schematic diagram illustrating an example in which real size display processing is executed on an operated object on the basis of real size information of an estimated subject of imaging;

FIG. 38A is a schematic diagram illustrating an example in which the sizes and positions of the faces of video-chatting users are different from each other;

FIG. 38B is a schematic diagram illustrating an example in which the sizes and positions of the faces of video-chatting users are generally uniformed by executing normalization processing between two or more images;

FIG. 39A is a schematic diagram illustrating an example in which the sizes and positions of a user and an instructor to be displayed in parallel to the screen are not aligned;

FIG. 39B is a schematic diagram illustrating an example in which the sizes and positions of the image of a user and the image of an instructor to be displayed in parallel to the screen are aligned by normalization processing between two or more images;

FIG. 39C is a schematic diagram illustrating an example in which the image of a user normalized by the normalization processing between two or more images is superimposed with the image of an instructor;

FIG. 40A is a schematic diagram illustrating an example in which the sample image of a product is not superimposed with the image of a user in a correct size relation;

FIG. 40B is a schematic diagram illustrating an example in which the sample image of a product is correctly superimposed with the image of a user by the normalization processing between two or more images;

FIG. 41 is a block diagram illustrating an exemplary internal configuration in order for the computation section to execute image normalization processing;

FIG. 42 is a schematic diagram illustrating a exemplary display form in which an entire area of video content is displayed such that the video content is not hidden at a given rotational angle;

FIG. 43 is a schematic diagram illustrating a display form in which a focus area in video content is maximized at a given rotational angle;

FIG. 44 is a schematic diagram illustrating a display form in which video content is rotated such that there is no invalid area;

FIG. 45 is a schematic diagram illustrating zoom ratios of video content relative to rotational positions in the display forms shown in FIG. 42 through FIG. 44;

FIG. 46 is a flowchart indicative of a processing procedure for controlling video content display forms in the computation section when rotating the information processing apparatus; and

FIG. 47 is a block diagram illustrating an exemplary internal configuration in order for the computation section to adjust a video content display form at a given rotational angle of the information processing apparatus or in the transition process of the rotation.

### DETAILED DESCRIPTION OF THE PREFERRED EMBODIMENTS

The following describes in details embodiments of the technology disclosed herein with reference to accompanying drawings.

### (A) System Configuration

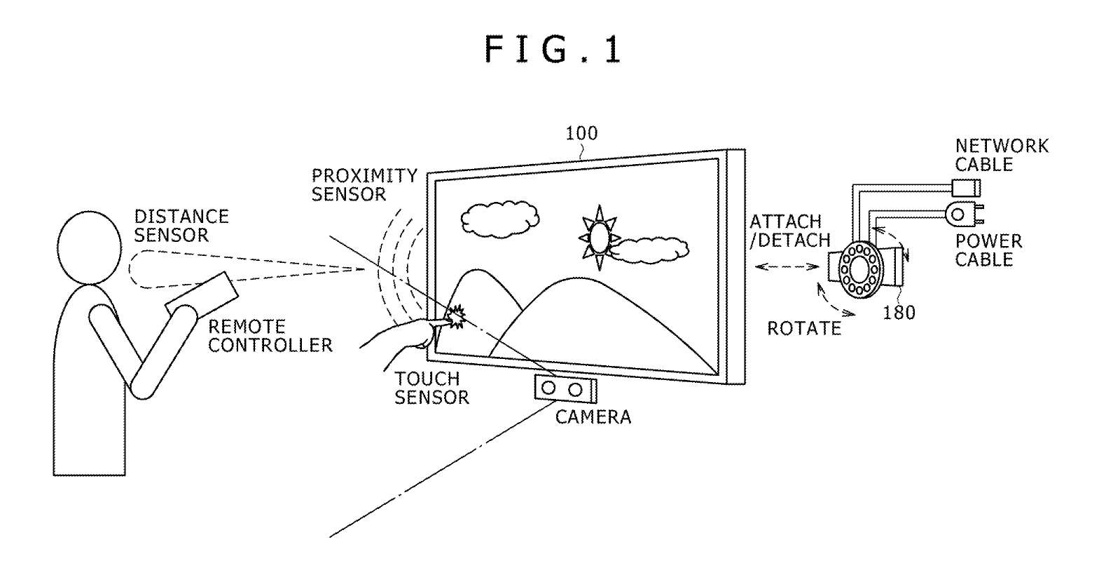

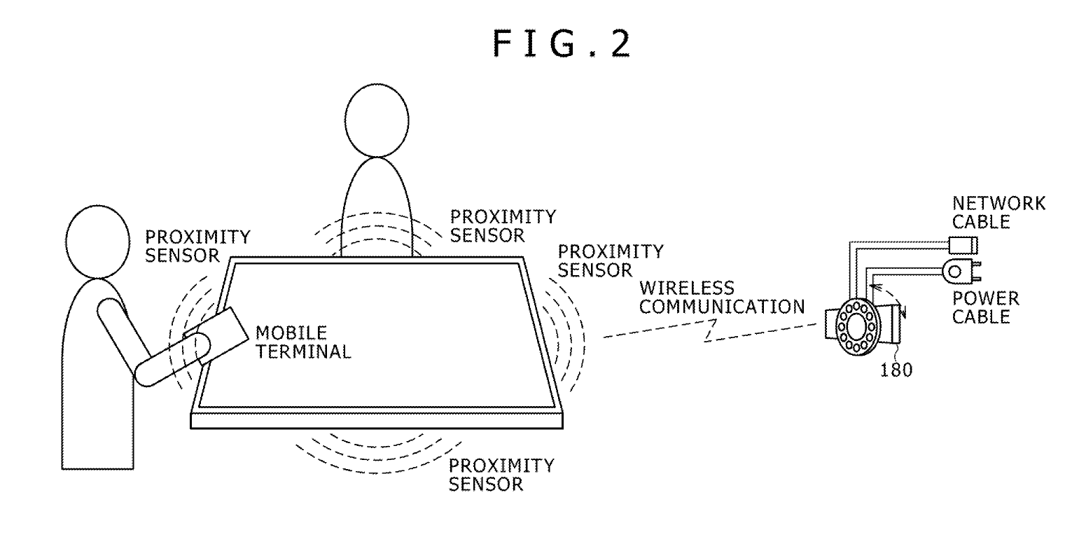

The information processing apparatus 100 practiced as one embodiment of the present technology has a large-size screen that is supposed for use on the wall as shown in FIG. 1 or on the tabletop as shown in FIG. 2.

In the wall state shown in FIG. 1, the information processing apparatus 100 is rotatably and detachably installed on the wall with a rotation/mount mechanism block 180 for example. The rotation/mount mechanism block 180 also functions as an electrical contact between the information processing apparatus 100 and the outside. Through this rotation/mount mechanism block 180, a power cable and a network cable (both not shown) are connected to the information processing apparatus 100. Consequently, the information processing apparatus 100 can receive a drive electric power from a commercial AC (Alternating Current) power supply and access various servers on the Internet.

As will be described later, the information processing apparatus 100 has a distance sensor, a proximity sensor, and a touch sensor, thereby recognizing the position (distance and bearing) of the user facing the screen of the information processing apparatus 100. Upon detection of the user or while the user is in the detected state, the information processing apparatus 100 shows a wave-ring shaped indicator (to be described later) and an illumination representation indicative of a detected state, for example, on the screen, thereby providing a visual feedback to the user.

The information processing apparatus 100 is configured to automatically select an optimum interaction in accordance with a user position. For example, in accordance with a user position, the information processing apparatus 100 automatically selects or adjusts a GUI (Graphical User Interface) indication, such as a framework of object to be operated and information density. In addition, the information processing apparatus 100 can automatically select one of two or more input means including the touch, proximity, gesture with hand toward the screen, a remote controller, and an indirect operation based on user state in accordance with a user position or a distance from the user, for example. Hereinafter, “an object to be operated” will be also referred to as “an operated object” for simplicity.

Further, the information processing apparatus 100 has one or more cameras in order to recognize not only a user position but also a person, an object, and a device on the basis of images taken by one or more cameras. Still further, the information processing apparatus 100 has an ultra near-field communication block to execute direct and smooth data transmission/reception with a device owned by the user entering in the ultra near field around the information processing apparatus 100.

On the large-size screen in the wall state, operated objects to be operated by the user are defined. Each operated object has a particular display area for a functional module such as a given Internet site, application, or a widget, in addition to a moving image, a still image, or text content, for example. Operated objects include received content of television broadcasting, content reproduced from recording media, a streaming moving image captured through a network, moving image content and still image content captured from another device such as a user's mobile terminal, and so on.

If the rotational position of the information processing apparatus 100 put on the wall is set so as to put the large-size screen into the landscape state as shown in FIG. 1, a video may be displayed as a world as it is that is generally drawn by movie as an operated object having the size of the entire screen.

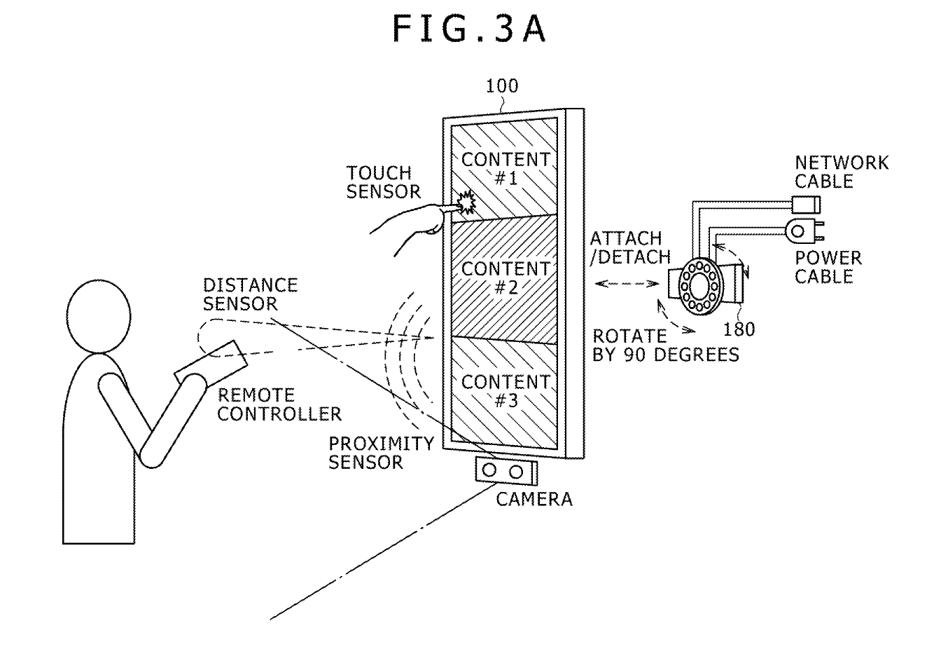

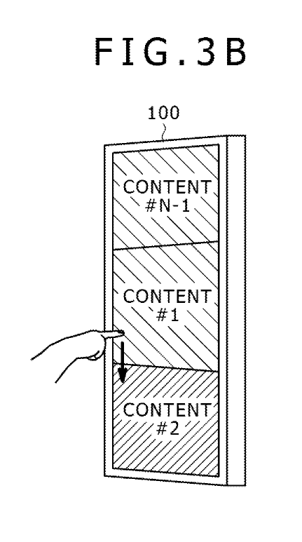

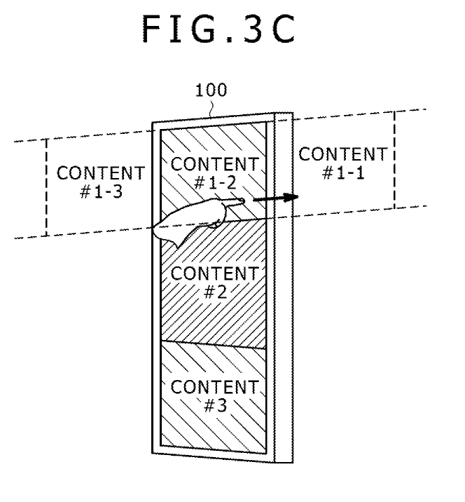

If the rotational position of the information processing apparatus 100 put on the wall is set so as to put the large-size screen in the portrait state, then three screens each having an aspect ratio 16 to 9 may be vertically arranged as shown in FIG. 3A. For example, three kinds of content #1 through #3, namely, broadcast content simultaneously received from different broadcasting stations, content reproduced from recording media, and a streaming moving image on a network may be displayed at a time as arranged vertically. In addition, if the user operates the screen up and down for example with user's finger, the displayed content is accordingly scrolled up and down as shown in FIG. 3B. If the user horizontally operates the screen with user's finger at any one of the three stacked screens, then the screen horizontally scrolls at the operated stack of screen.

On the other hand, in the tabletop state shown in FIG. 2, the information processing apparatus 100 is installed directly on a table. In the wall state shown in FIG. 1, the rotation/mount mechanism block 180 also functions as an electric contact (as described above). In the tabletop mounted state as shown in FIG. 2, there is no electric contact to the information processing apparatus 100. Therefore, in the tabletop state shown, the information processing apparatus 100 may be configured so as to be operable on the build-in buttery without resorting to the external power supply. In addition, if the information processing apparatus 100 is arranged with a wireless communication block equivalent to a mobile station function of wireless LAN (Local Area Network) for example and the rotation/mount mechanism block 180 has a wireless communication block equivalent to a wireless LAN access point function, then the information processing apparatus 100 can access various servers on the Internet through the wireless communication with the rotation/mount mechanism block 180 as an access point in the tabletop state.

On the large-size screen in the tabletop state, two or more operated objects to be operated are defined. Each operated object has a particular display area for a functional module such as a given Internet site, application, or a widget, in addition to a moving image, a still image, or text content, for example.

The information processing apparatus 100 has a proximity sensor on each of the four rims of the large-size screen for detecting the presence or state of a user. As described above, a user approaching the large-size screen may be taken with a camera for personal recognition. In addition, an ultra near-field communication block detects whether the user whose presence has been detected has a device such as a mobile terminal and a data transmission/reception request from another terminal held by the user. Upon detection of a user or a terminal held by the user or in the user-detected state, illuminated representation (to be described later) indicative of a wave-ring shaped detection indicator or a detection state is executed on the screen, thereby providing the user with a visual feedback.

Upon detection of the presence of a user with a proximity sensor for example, the information processing apparatus 100 uses the detection results for UI (User Interface) control. Detecting the position of user's body, hands and feet, or head in addition to the presence of the user allows more detail UI control. In addition, the information processing apparatus 100 has an ultra near-field communication block by which direct and smooth data transmission/reception with a device owed by a user entering in an ultra near field (as described above).

For one example of UI control, the information processing apparatus 100 sets a user occupied area for each user and a common area shared by two or more users in the large-size screen in accordance with the arrangement of detected users. Then, the information processing apparatus 100 detects the touch sensor input by each user in the user occupied area and the common area. It should be noted that a screen shape and area partitioning pattern are not limited to rectangles; namely, these patterns may include any shapes such as squares and circles, and cubes such as cones, for example.

Increasing the size of the screen of the information processing apparatus 100 provides a room in space wide enough for two or more users to execute touch input operations at the same time. As described above, setting the user occupied area for each user and the common area allows the realization of smooth and efficient simultaneous operations done by two or more users.

The operation privilege of an operated object placed in a user occupied area is given to the corresponding user. When a user moves an operated object to the user's own user occupied area from the common area or the user occupied area of another user, the operation privilege of the moved operated object is transferred to that user. When an operated objects enters the user occupied area of a user, the display is automatically changed in which the operated object is directly faced to that user.

When an operated object moves between user occupied areas, the operated object moves in a physically smoothly in accordance with a touch position at which the move operation has been done. In addition, pulling one operated object by two or more users allows the division or duplication of the pulled operated object.

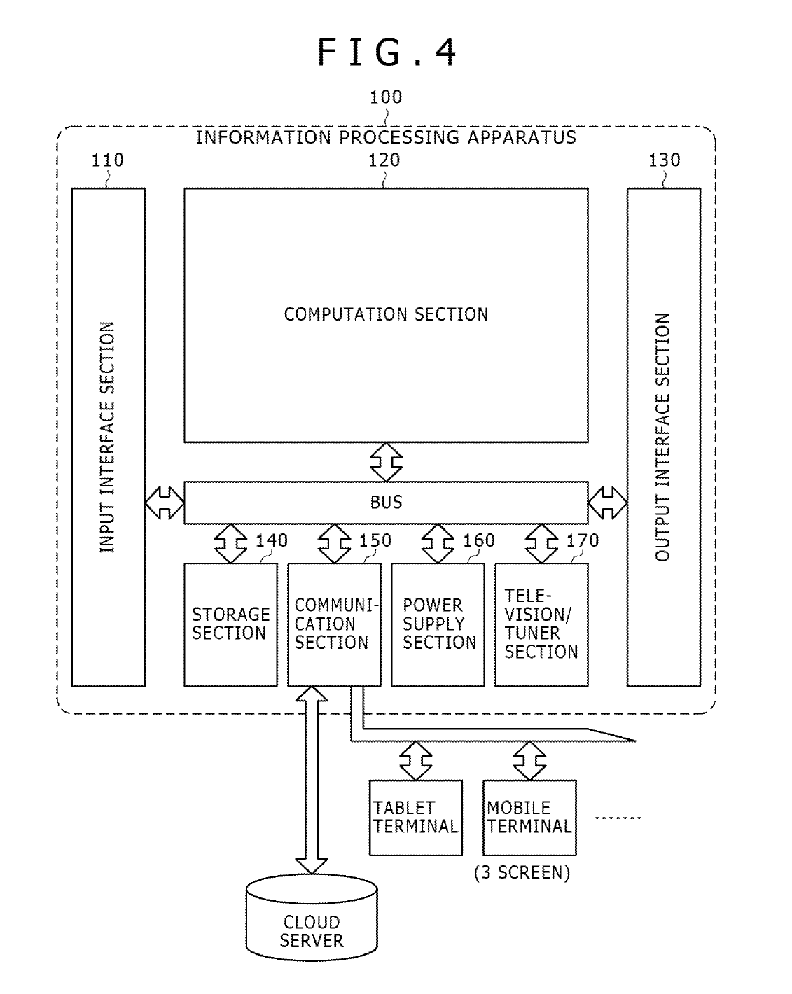

FIG. 4 schematically shows an exemplary functional configuration of the information processing apparatus 100. The information processing apparatus 100 has an input interface section 110 through which an external information signal is entered, a computation section 120 for executing computation processing for controlling a display screen on the basis of the entered information signal, an output interface section 130 through which information obtained on the basis of a computation processing result is transmitted to the outside, a storage section 140 of high capacity made up of a hard disk drive (HDD) for example, a communication section 150 for communicating with an outside network, a power supply section 160 handling drive power, and a television/tuner section 170. The storage section 140 stores various processing algorithms to be executed by the computation section 120 and various databases for use in computation processing to be executed by the computation section 120.

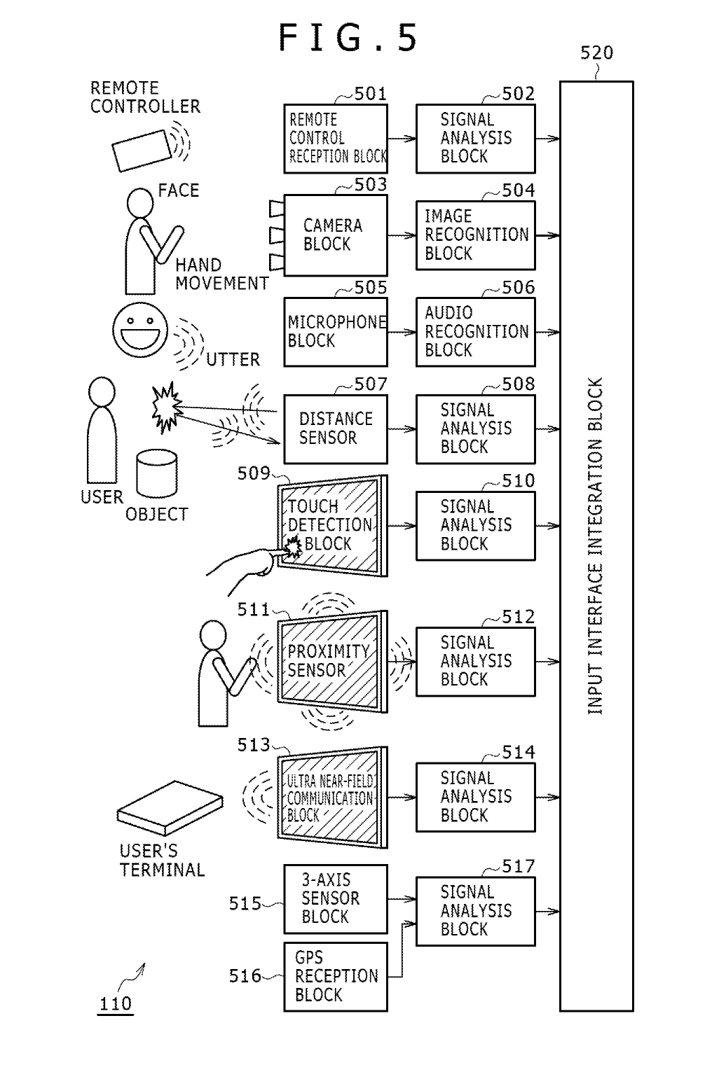

The main functions of the input interface section 110 include the detection of user presence, the detection of a touch operation done on the screen, namely, the touch panel, by the detected user, the detection of a device such as a user's mobile terminal, and the processing of receiving transmission data supplied from the device. FIG. 5 shows an exemplary internal configuration of the input interface section 110.

A remote control reception block 501 receives a remote control signal supplied from a remote controller or a mobile terminal. A signal analysis block 502 demodulates a received remote control signal and decodes the demodulated remote control signal, thereby providing a remote control command.

A camera block 503 has a monocular/binocular and/or active type camera mechanism. The camera is based on an imaging element, CMOS (Complementary Metal Oxide Semiconductor) or CCD (Charge Coupled Device). The camera block 503 also has a camera control block for executing panning, tilting, and zooming. The camera block 503 can transmit camera information such as panning, tilting, and zooming to the computation section 120 and control panning, tilting, and zooming by the camera block 503 in accordance with camera control information supplied from the computation section 120.

An image recognition block 504 recognizes taken images taken by the camera block 503. To be more specific, the image recognition block 504 recognizes a gesture done by a user by detecting the movements of the user's face and hand on the basis of background difference, the user's face included in a taken image, a human body included in an taken image, and the distance from the user, for example.

A microphone block 505 is used to pick up sounds and the voice uttered by the user. An audio recognition block 506 recognizes the picked up audio signal.

A distance sensor 507, made up of PSD (Position Sensitive Detector) for example, detects a signal returned from a user or an object. A signal analysis block 508 measures the distance from a user or an object by analyzing the detected signal. In addition to a PDS sensor, a pyroelectric sensor or a simplified camera may be used for the distance sensor 507. The distance sensor 507 is always monitoring if there is a user within a radius of five to ten meters for example from the information processing apparatus 100. For this reason, it is desirable to use a sensor element of comparatively small power dissipation for the distance sensor 507.

A touch detection block 509, made up of a touch sensor superimposed with the screen for example, outputs a detection signal from a position at which user's finger touches on the screen. A signal analysis block 510 analyzes this detection signal to obtain positional information.

A proximity sensor 511, arranged on each of the four rims of the large-size screen, detects the approach of a user's body close to the screen in an electrostatic capacitive manner. A signal analysis block 512 analyzes this detected signal.

An ultra near-field communication block 513 receives a noncontact communication signal supplied from a device held by the user for example through NFC (Near Field Communication). A signal analysis block 514 demodulates the received noncontact communication signal and decodes the demodulated signal to obtain reception data.

A three-axis sensor block 515 is configured by a gyro for example and detects postures around each of x, y, and z axes of the information processing apparatus 100. A GPS (Global Positioning System) reception block 516 receives signals from a GPS satellite. A signal analysis block 517 analyzes signals coming from the three-axis sensor block 515 and the GPS reception block 516 to obtain the positional information and posture information associated with the information processing apparatus 100.

An input interface integration block 520 integrates the above-mentioned inputs of information signals and passes an integrated signal to the computation section 120. The input interface integration block 520 integrates the analysis results of the signal analysis block 508, the signal analysis block 510, the signal analysis block 512, and the signal analysis block 514 to obtain the positional information of a user located around the information processing apparatus 100, thereby passing the obtained positional information to the computation section 120.

The main functions of the computation section 120 include the computation processing such as UI screen generation processing to be executed on the basis of a user detected result and a screen touch detected result supplied from the input interface section 110 and the data received from the a device held by the user and the outputting of a computation result to the output interface section 130. The computation section 120 loads an application program from the storage section 140 for example and executes the loaded application, thereby realizing the computation processing for each application. An exemplary functional configuration of the computation section 120 corresponding to each application will be described later.

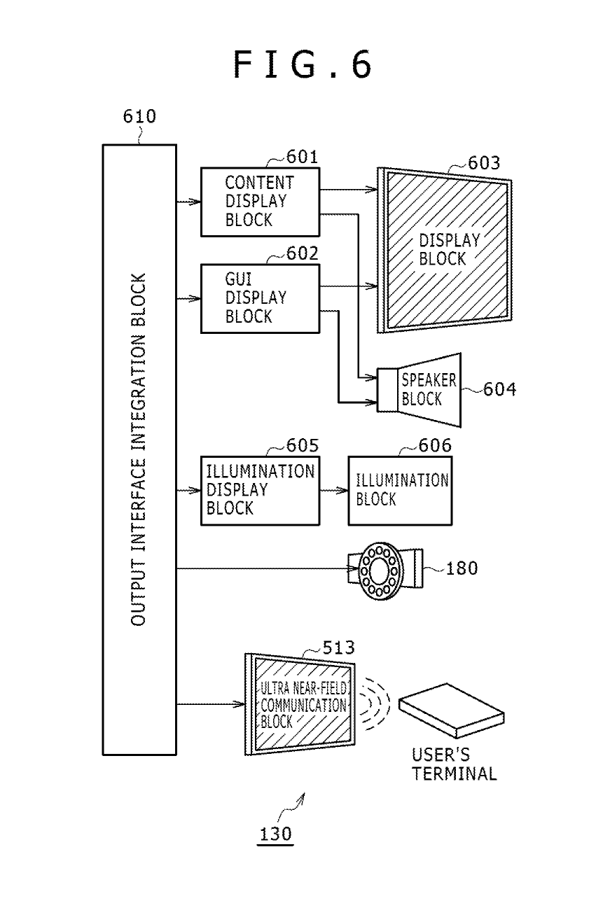

The main functions of the output interface section 130 include the execution of UI display on the screen on the basis of a computation result supplied from the computation section 120 and the transmission of data to the device held by the user. FIG. 6 shows an exemplary internal configuration of the output interface section 130.

An output interface integration block 610 integrally handles the information outputs obtained on the basis of the computation results of monitor partition processing, object optimization processing, and device-associated data transmission/reception processing executed by the computation section 120, for example.

The output interface integration block 610 instructs a content display block 601 to output received television broadcast content and the content reproduced from recording media such as Blu-ray disc to a display block 603 for displaying still image content and moving image content and a speaker block 604.

In addition, the output interface integration block 610 instructs a GUI display block 602 to display GUIs such as operated objects onto the display block 603.

Further, the output interface integration block 610 instructs an illumination display block 605 to output illumination display indicative of a detection state supplied from an illumination block 606.

Still further, the output interface integration block 610 instructs the ultra near-field communication block 513 to execute data transmission based on noncontact communication to the device held by the user for example.

The information processing apparatus 100 can detect a user on the basis of the recognition of an image taken by the camera block 503 and detection signals supplied from the distance sensor 507, the touch detection block 509, the proximity sensor 511, and the ultra near-field communication block 513. In addition, the information processing apparatus 100 can identify the person of the detected user by the face recognition in an image taken by the camera block 503 and the recognition of a device held by the user through the ultra near-field communication block 513. The identified user can log in on the information processing apparatus 100. Obviously, the login account may be restricted to particular users. In addition, in accordance with a user position and a user state, the information processing apparatus 100 can use any of the distance sensor 507, the touch detection block 509, and the proximity sensor 511 to receive an operation from the user.

Further, the information processing apparatus 100 is connected to an external network via the communication section 150. The form of the connection with an external network may be wired or wireless. Through the communication section 150, the information processing apparatus 100 can communicate with a mobile terminal such as a so-called smart phone held by the user and another device such as a tablet terminal. The information processing apparatus 100, a mobile terminal, and a tablet terminal may configure a so-called three screen monitor. The information processing apparatus 100 may provide UI for three screen monitor coordination on the screen that is larger in size than the other two screens of the mobile terminal and the tablet terminal.

For example, while the user is executing an action such as touching the screen for operation or moving the terminal of the user close to the information processing apparatus 100, the transmission/reception of data such as the content like a moving image, a still image, or a text content that are the substance of an operated object is executed between the information processing apparatus 100 and the corresponding terminal held by the user. In addition, a cloud server is arranged on an external network, and the three screen monitor can benefit from cloud computing in the user of cloud server computation performance through the information processing apparatus 100.

The following describes some applications to be run by the information processing apparatus 100.

### (B) Simultaneous Operations by Two or More Users on the Large-Size Screen

The information processing apparatus 100 allows the simultaneous operations done by two or more users on the large-size screen. To be more specific, the information processing apparatus 100 has the proximity sensor 511 for detecting user's presence or state on each of the four rim sections of the large-size screen. Setting a user occupied area and a common area inside the screen in accordance with the arrangement of the user allows comfortable and efficient simultaneous operations by two or more users.

Increasing the size of the screen of the information processing apparatus 100 provides a spatial room large enough for the simultaneous touch input by two or more users in the tabletop state. As described above, setting a user occupied area and a common area for each user within the screen realizes the conformable and efficient simultaneous operation by two or more users.

The operation privilege of an operated object placed in the user occupied area is given to the corresponding user. When the user moves an operated object from the common area or the user occupied area of another user to the user occupied area of the moving user, the operation privilege of the moved operated object belongs to the moving user. When the operated object enters the user occupied area of the moving user, this operated object is automatically faced directly to the moving user.

If an operated object is moved between user occupied areas, the operated object is physically smoothly moved in accordance with a touch position at which the move operation has been done. In addition, pulling one operated object by two or more users allows the division or duplication of the pulled operated object.

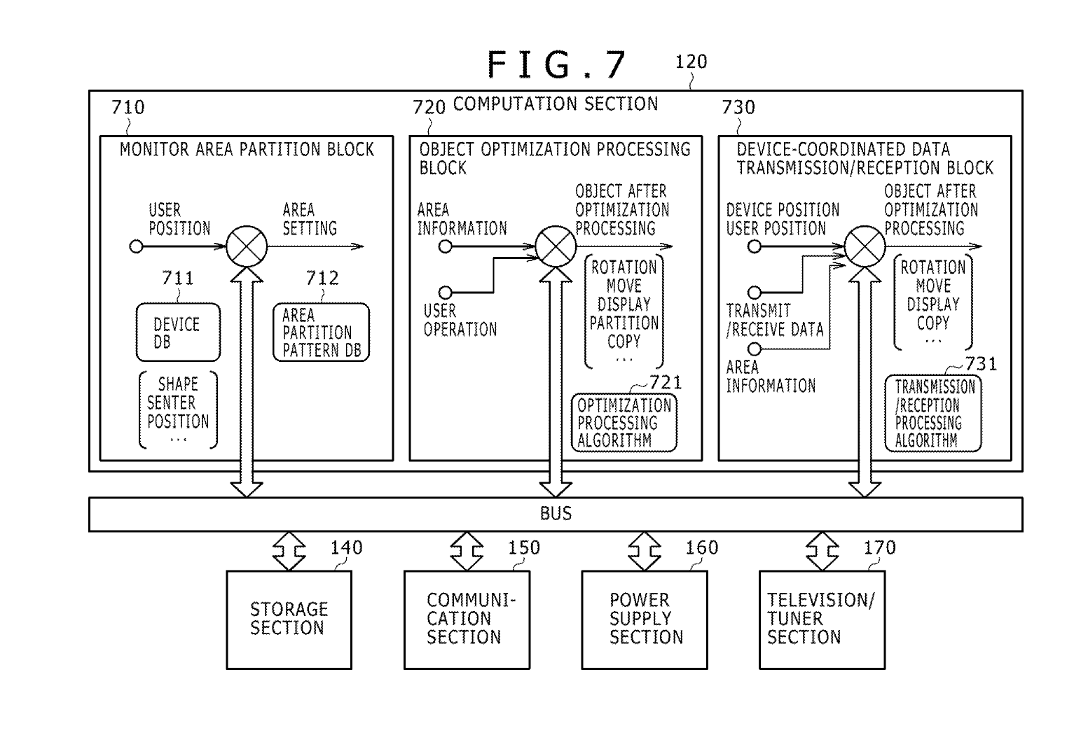

The main functions of the computation section 120 for realizing the above-mentioned application include the optimization of an operated object on the basis of a user detection result obtained by the input interface section 110, a screen touch detection result, and the data received from a device held by the user and the generation of UI. FIG. 7 shows an exemplary internal configuration in order for the computation section 120 to execute the processing of an operated object. The computation section 120 has a monitor area partition block 710, an object optimization processing block 720, and a device-coordinated data transmission/reception block 730.

Upon receiving user positional information from the input interface integration block 520, the monitor area partition block 710 references a device database 711 associated with shape and sensor arrangement and an area partition pattern database 712 to set a user occupied area and a common area described above on the screen. Then, the monitor area partition block 710 passes the setting area information to the object optimization processing block 720 and the device-coordinated data transmission/reception block 730. Details of a processing procedure of monitor area partitioning will be described later.

The object optimization processing block 720 enters information an operation done by the user on an operated object on the screen from the input interface integration block 520. Then object optimization processing block 720 executes such optimization processing on the operated object corresponding to the user operation as rotation, move, display, partition or copy on the operated object operated by the user in accordance with an optimization processing algorithm 721 loaded from the storage section 140, thereby outputting the optimized operated object to the screen of the display block 603. Details of the object optimization processing will be described later.

The device-coordinated data transmission/reception block 730 enters positional information of a device held by the user and data transmitted/received to/from this device from the input interface integration block 520. Then, the device-coordinated data transmission/reception block 730 executes data transmission/reception processing in coordination with the device held by the user in accordance with a transmission/reception processing algorithm 731 loaded from the storage section 140. In addition, the device-coordinated data transmission/reception block 730 executes optimization processing on the corresponding operated object. Details of object optimization processing will be described later. The device-coordinated data transmission/reception block 730 executes such optimization processing on the operated object corresponding to the transmission/reception data in coordination with the device held by the user as rotation, move, display, or copy on the operated object associated with the transmission/reception data, thereby outputting the optimized operated object to the screen of the display block 603. Details of the object optimization processing involved in device coordination will be described later.

The following describes the details of monitor area partition processing. For monitor area partitioning, the processing in the usage form in which the information processing apparatus 100 is mainly used by two or more users in the tabletop state is assumed. Obviously, monitor area partitioning may be executed in the wall state.

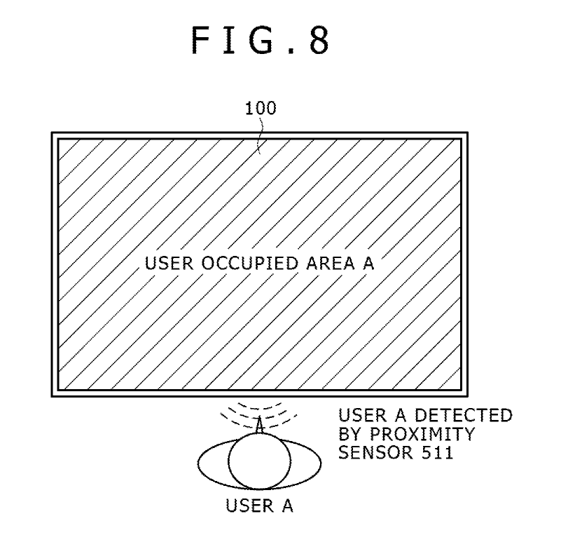

Upon detecting user presence through the input interface integration block 520, the monitor area partition block 710 allocates the user occupied area of the detected user to the screen. FIG. 8 shows how user occupied area A of user A is set in the screen by the monitor area partition block 710 upon detection of the presence of user A by a detection signal of the proximity sensor 511 (or the distance sensor 507) arranged on one rim of the screen. If the presence of one user has been detected, then the entire screen may be set as the user occupied area of the detected user as shown.

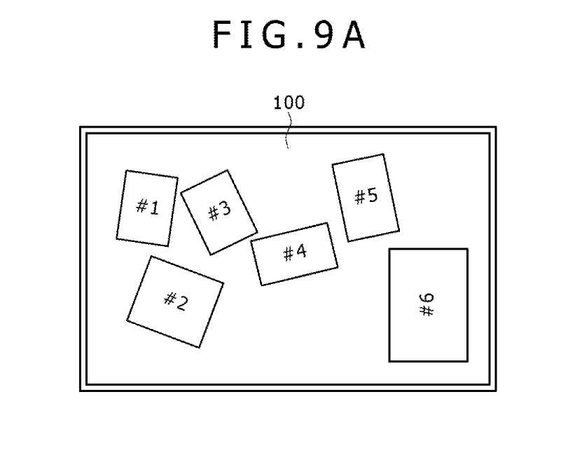

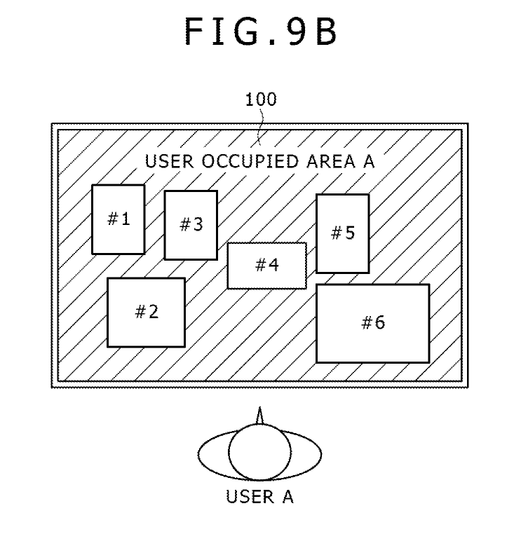

When user occupied area A is set, the object optimization processing block 720 switches the orientation of each operated object in user occupied area A such that each operated object directly faces user A on the basis of the positional information of user A obtained through the input interface integration block 520. FIG. 9A shows how operated objects #1 through #6 are randomly directed before user occupied area A is set. FIG. 9B shows how the directions of all of operated objects #1 through #6 have been switched to face user A in user occupied area A after user occupied area A of user A has been set.

If the presence of only user A has been detected, then the entire screen may be set to user occupied area A of user A. On the other hand, if the presence of two or more users has been detected, then it is desirable to set a common area to be shared by these users for the execution of a collaborative action.

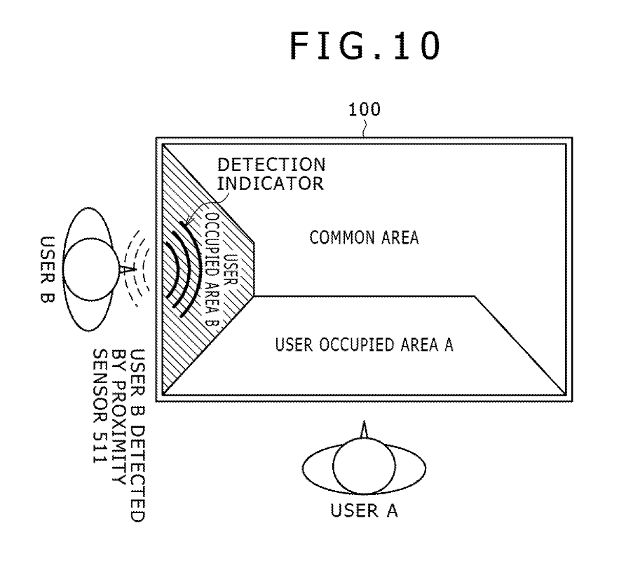

FIG. 10 shows how the monitor area partition block 710 has set user occupied area B of user B and a common area to the screen in addition to user A upon detection of the presence of user B on an adjacent screen rim on the basis of a detection signal supplied from the proximity sensor 511 or the distance sensor 507. On the basis of the positional information of user A and user B, user occupied area A of user A shrinks in the direction of user A and user occupied area B of user B appears near the position of user B. At the same time, the detection of user B causes to display a ripple-like detection indicator in user occupied area B. Then, the area other than user occupied areas A and B in the screen becomes a common area. It is also practicable, after the setting of user occupied area B caused by the approaching by user B to the information processing apparatus 100, to validate user occupied area B when any of operated objects in user occupied area B is touched for the first time. It should be noted that, although not shown in FIG. 10, each operated object in new user occupied area B is changed in direction such that each operated object faces user B upon setting of user occupied area B or validation of user occupied area B.

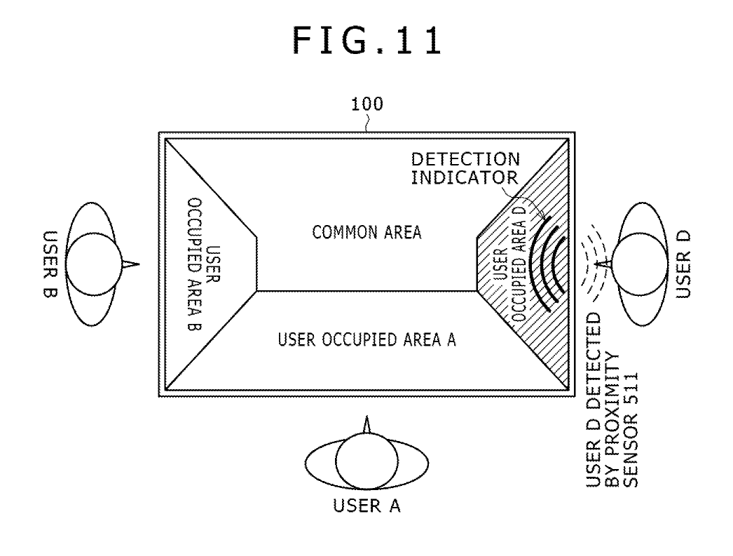

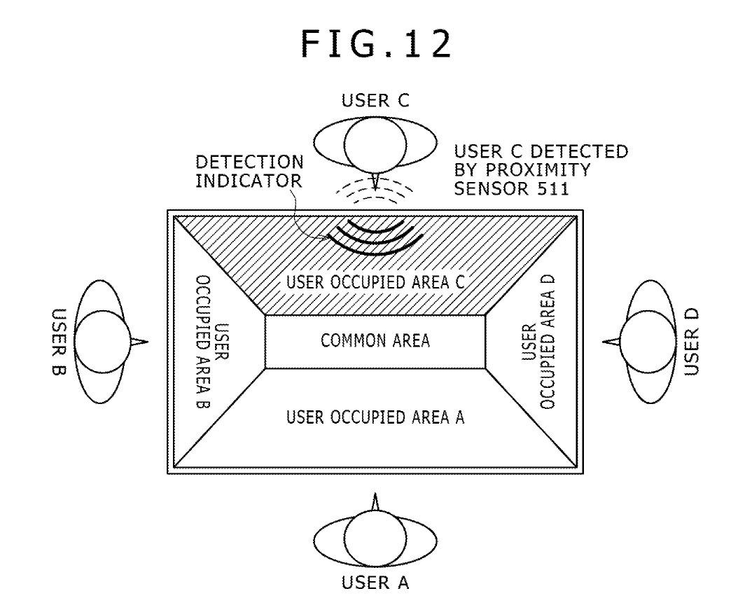

FIG. 11 shows how the monitor area partition block 710 has set user occupied area D to the screen near the position of user D upon detection of the presence of user D on still another rim of the screen, in addition to user A and user B. In user occupied area D, a ripple-like detection indicator is displayed to express the detection of the presence of user D. FIG. 12 shows how the monitor area partition block 710 has set user occupied area C to the screen near the position of user C upon detection of the presence of user C on yet another rim of the screen, in addition to user A, user B, and user D. In user occupied area C, a ripple-like detection indicator is displayed to express the detection of the presence of user C.

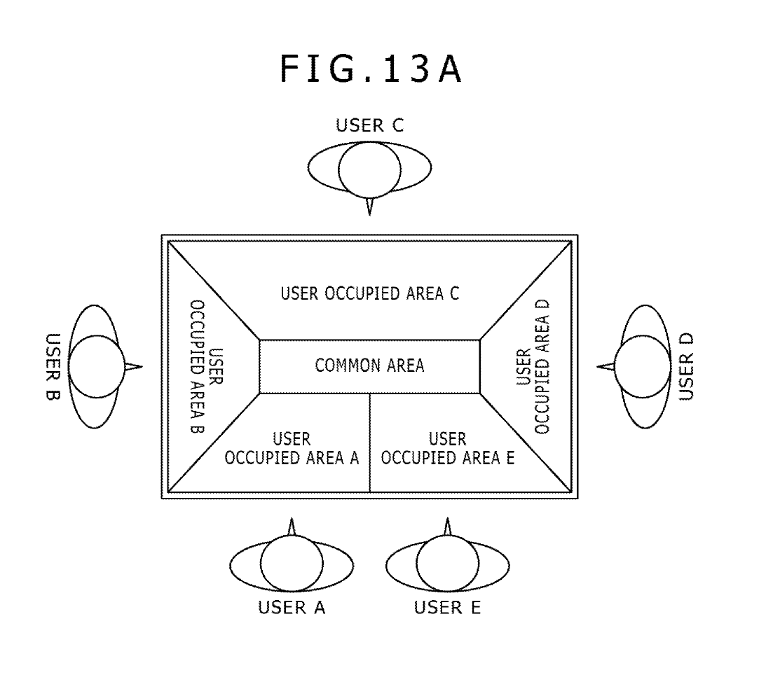

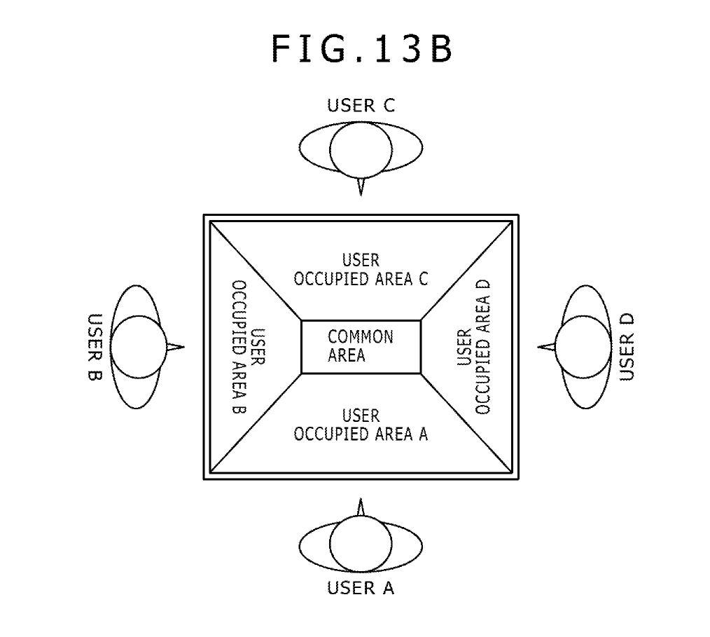

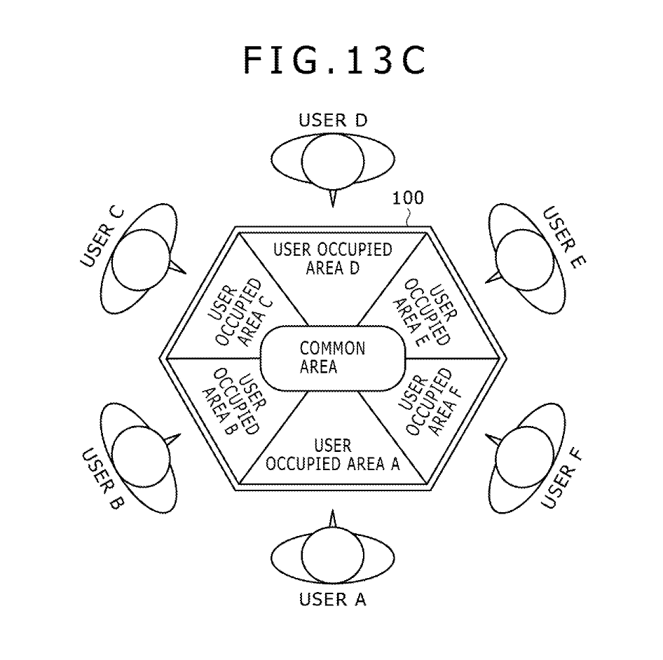

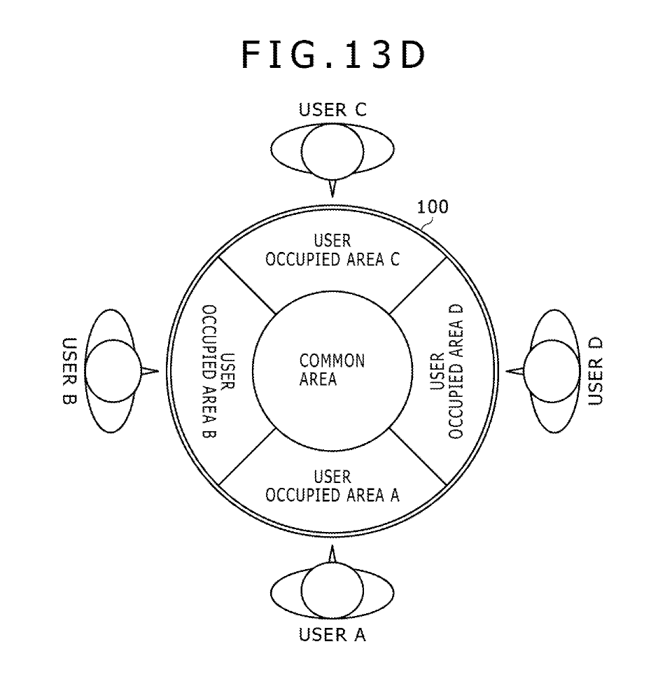

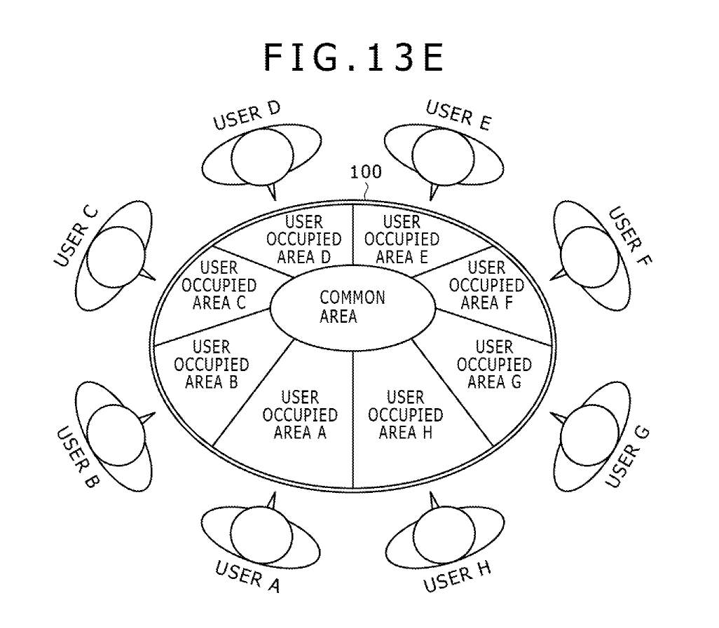

It should be noted that the area partition patterns of the user occupied areas and the common areas shown in FIG. 8 through FIG. 12 are illustrative only. Each area partition pattern depends on the shape of screen, the number of users of which presence was detected, and the arrangement of detected users. An area partition pattern database 712 stores the information associated with the area partition patterns in accordance with the screen shape and size and the number of users. A device database 711 stores the information associated with the shapes and sizes of the screens to be used by the information processing apparatus 100 concerned. When the positional information of a user detected through the input interface integration block 520 is entered, the monitor area partition block 710 reads the shape and size of the screen from the device database 711 and refers the area partition pattern database 712 for an area partition pattern. FIG. 13A through FIG. 13E each show exemplary area partition patterns for partitioning the screen into the user occupied area of each user in accordance with the shape and size of the screen and the number of users.

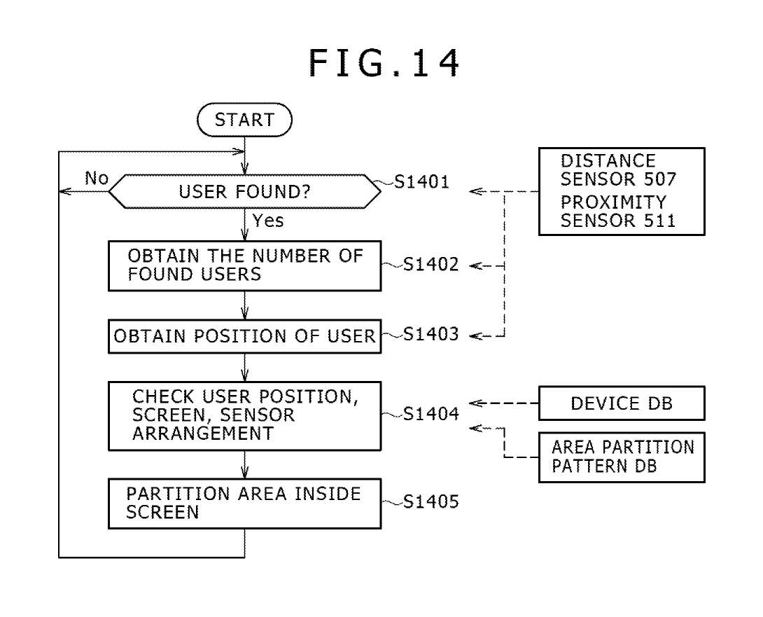

FIG. 14 shows a processing procedure of the monitor area partitioning to be executed by the monitor area partition block 710 in the form of a flowchart.

First, the monitor area partition block 710 checks if there is a user around the screen on the basis of a signal analysis result of a detection signal supplied from the proximity sensor 511 or the distance sensor 507 (step S1401).

If a user is found present (Yes of step S1401), then the monitor area partition block 710 obtains the number of users present (step S1402) and then obtains the position of each user (step S1403). The processing operations of step S1401 through step S1403 are realized on the basis of the positional information of each user received from the input interface integration block 520.

Next, the monitor area partition block 710 refers the device database 711 for such device information as the screen shape of the display block 603 to be used by the information processing apparatus 100 and the arrangement of the proximity sensor 511 and, on the basis of the obtained device information plus the user positional information, refers the area partition pattern database 712 for a corresponding area partition pattern (step S1404).

Then, in accordance with the obtained area partition pattern, the monitor area partition block 710 sets a user occupied area for each user and a common area on the screen (step S1405), upon which this processing routine comes to an end.

The following describes the details of the object optimization processing to be executed by the object optimization processing block 720.

When the information about an operation done on an operated object on the screen by the user through the input interface integration block 520 is entered, the object optimization processing block 720 executes such display processing as rotation, movement, display, partition, or copy on the operated object on the screen in accordance with a user operation. Such display processing as rotation, movement, display, partition, or copy to be executed by drag and throw operations for example by the user is similar to a GUI operation on the desktop screen of a computer.

In the present embodiment, a user occupied area and a common area are set on the screen, so that the object optimization processing block 720 optimizes the display of these areas in accordance with the area in which there is an operated object. A typical example of the optimization processing is to switch the directions of each operated object in the user occupied area such that each operated object faces this user.

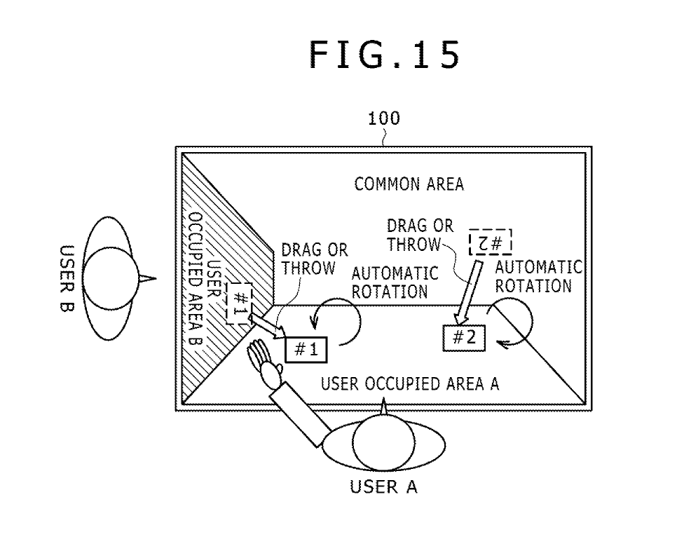

FIG. 15 shows how the object optimization processing block 720 automatically rotates operated object #2 in the direction facing user A when operated object #2 in user occupied area B of user B is dragged or thrown to user occupied area A of user A and a part or the center coordinate of operated object #2 enters user occupied area A. FIG. 15 also shows how the object optimization processing block 720 automatically rotates operated object #1 in the direction facing user A when operated object #1 in user occupied area B of user B is dragged or thrown to user occupied area A of user A and a part or the center coordinate of operated object #1 enters user occupied area A.

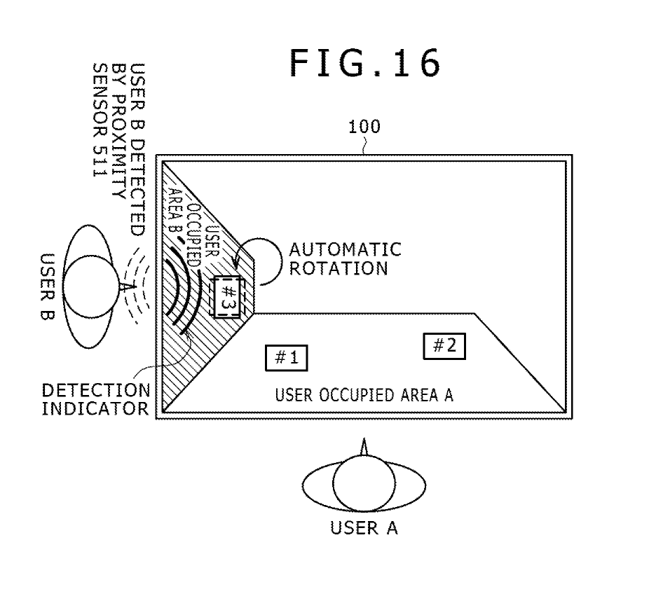

As shown in FIG. 10, when user B approaches the information processing apparatus 100, user occupied area B is newly set near user B on the screen. If operated object #3 is present facing user A in user occupied area B, then, if user occupied area B newly appears as shown in FIG. 16, then the object optimization processing block 720 immediately automatically rotates operated object #3 in the direction facing user B.

Alternatively, instead of immediately automatically rotating the operated object, the object optimization processing block 720 may validate user occupied area B when any operated object in user occupied area B is first touched after user occupied area B is newly set upon approaching of user B to the information processing apparatus 100. In this case, when user occupied area B is validated, the object optimization processing block 720 may simultaneously rotate all operated objects in user occupied area B in the direction facing user B.

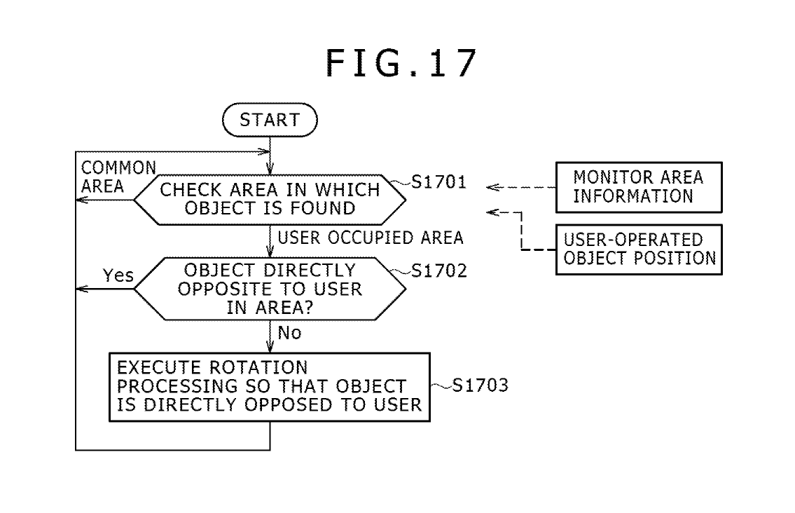

On the basis of the user operation information obtained through the input interface integration block 520 and the area information passed from the monitor area partition block 710, the object optimization processing block 720 can optimize operated objects. FIG. 17 shows a procedure of optimizing an operated object to be executed by the object optimization processing block 720 in the form of a flowchart.

When the object optimization processing block 720 receives the positional information of an operated object operated by the user from the input interface integration block 520 and obtains the monitor area information from the monitor area partition block 710, the object optimization processing block 720 checks in which area the operated object operated by the user is positioned (step S1701).

If the operated object operated by the user is found in a user occupied area, then the object optimization processing block 720 checks whether this operated object faces the user in this user occupied area or not (step S1702).

If the operated object is found to be not facing the user (No in step S1702), then the object optimization processing block 720 rotates the operated object such that the operated object faces the user in this user occupied area (step S1703).

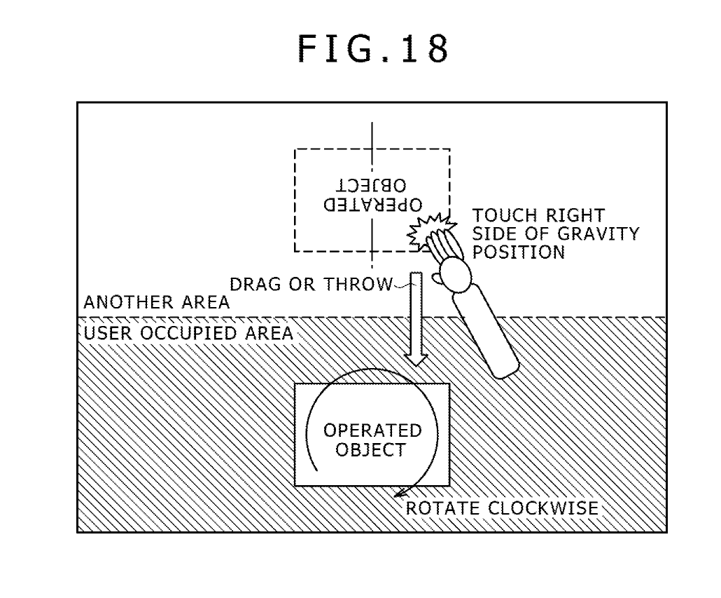

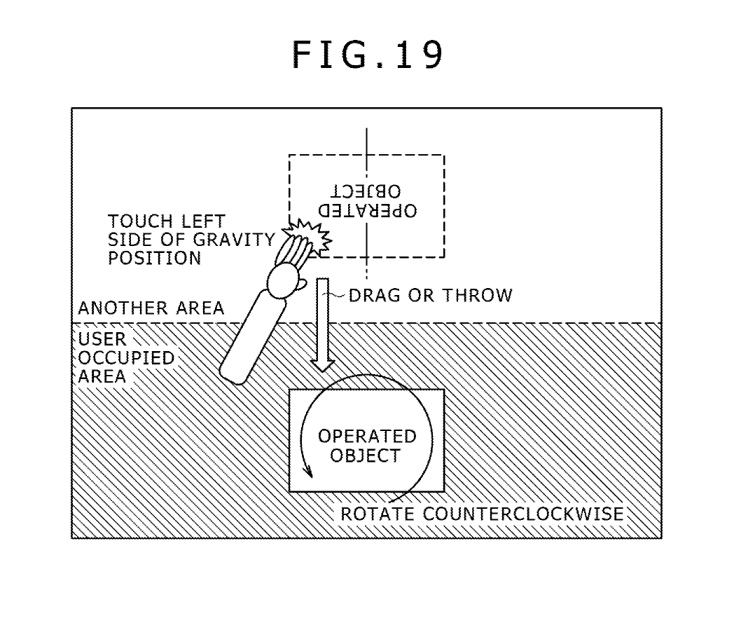

It is also practicable, when the user drags or throws an operated object from the common area or the user occupied area of another user to the own user occupied area, that the rotational direction of this operated object is controlled in accordance with a position at which the user touched this operated object. FIG. 18 shows how an operated object comes to face the user after clockwise rotation around the center-of-gravity position thereof when the user has touched the right side from the center-of-gravity position of the operated object to drag or throw and the dragged or thrown operated object has entered the user occupied area. FIG. 19 shows how an operated object comes to face the user after counterclockwise rotation around the center-of-gravity position thereof when the user has touched the left side from the center-of-gravity position of the operated object to drag or throw and the dragged or thrown operated object has entered the user occupied area.

As shown in FIG. 18 and FIG. 19, switching between the rotational directions of an operated object with reference to the center-of-gravity position thereof can provide the user with a natural sense of operation.

The following describes device-coordinated data transmission/reception processing to be executed by the device-coordinated data transmission/reception block 730.

As shown in FIG. 4, the information processing apparatus 100 is capable of communication with another device such as a mobile terminal held by the user through the communication section 150. For example, while the user is executing an action such as touching the screen for operation or moving the terminal of the user close to the information processing apparatus 100, the transmission/reception of data such as a moving image, a still image, or text content that are the substance of an operated object is executed between the information processing apparatus 100 and the corresponding terminal held by the user.

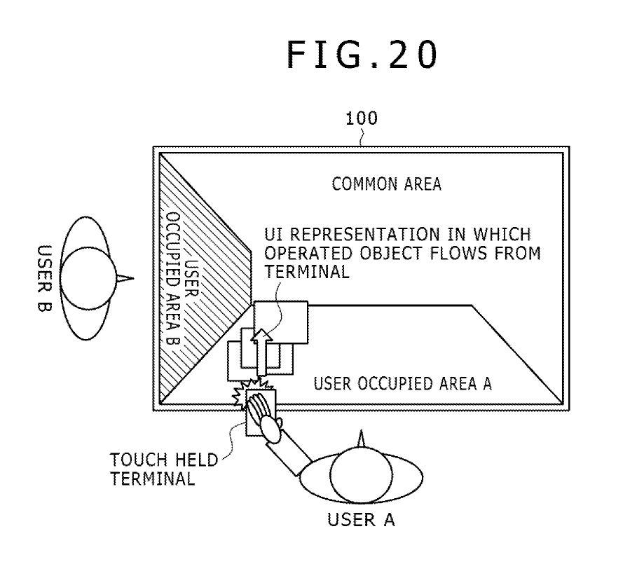

FIG. 20 shows an exemplary interaction in which an operated object is passed between the information processing apparatus 100 and a terminal held by the user. In this example shown in the figure, UI representation is executed that, in response to user A's getting the terminal held by user A closer to periphery of user occupied area A allocated to user A, an operated object appears from around the terminal to flow into user occupied area A.

On the basis of a signal analysis result of a detection signal by the ultra near-field communication block 513 and a recognition result of a user's image taken by the camera block 503, the information processing apparatus 100 can detect the approach of the terminal held by the user to user occupied area A. It is also practicable to configure the device-coordinated data transmission/reception block 730 to recognize whether there is data to be transmitted by the user to the information processing apparatus 100 or the contents of the transmission data through the context made so far between user A and the information processing apparatus 100 (or the transfer of data between user A and another user through the information processing apparatus 100). If transmission data is found, then the device-coordinated data transmission/reception block 730 executes the transmission/reception of data such as a moving image, a still image, or text content that is the substance of the operated object between the information processing apparatus 100 and the corresponding user terminal, while the user is getting the terminal held by the user closer to user occupied area A.

UI representation is executed such that, while the device-coordinated data transmission/reception block 730 executes data transmission/reception with the terminal held by the user, an operated object appears from the terminal held by the user by the object optimization processing executed by the object optimization processing block 720 on the screen of the display block 603. FIG. 20 shows exemplary UI representation in which an operated object flows from a user terminal into a corresponding user occupied area.

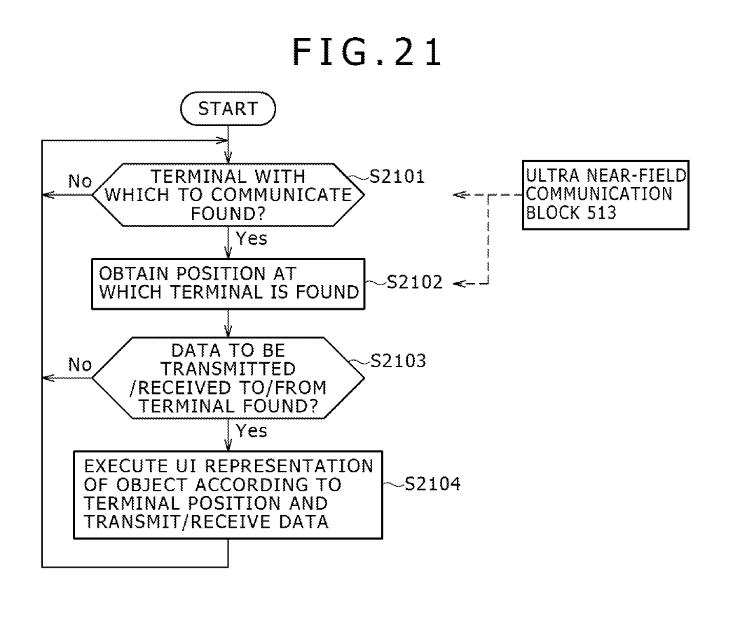

FIG. 21 shows a processing procedure of device-coordinated data transmission/reception to be executed by the device-coordinated data transmission/reception block 730 in the form of a flowchart. The processing to be executed by the device-coordinated data transmission/reception block 730 is activated when a terminal held by the user approaches user occupied area A on the basis of a signal analysis result of a detection signal by the ultra near-field communication block 513.

On the basis of a signal analysis result of a detection signal by the ultra near-field communication block 513, for example, the device-coordinated data transmission/reception block 730 checks if there is a terminal held by the user with which to communicate (step S2101).

If the terminal held by the user with which to communicate is found (Yes in step S2101), then the device-coordinated data transmission/reception block 730 obtains the position at which the terminal is found on the basis of a signal analysis result of a detection signal by the ultra near-field communication block 513 (step S2102).

Next, the device-coordinated data transmission/reception block 730 checks if there is data to be transmitted/received to/from this user terminal or not (step S2103).

If the data to be transmitted/received to/from the user terminal is found (Yes in step S2103), then the device-coordinated data transmission/reception block 730 executes UI representation (refer to FIG. 20) of an operated object in accordance with the position of the user terminal by following the transmission/reception processing algorithm 731. In addition, the device-coordinated data transmission/reception block 730 transmits/receives the data that is the substance of the operated object to/from the user terminal in the UI representation background (step S2104).

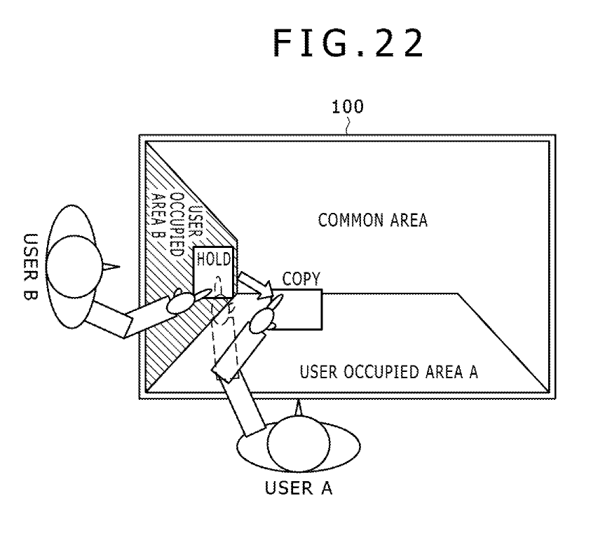

As shown in FIG. 20 and FIG. 21, an operated object that the information processing apparatus 100 has obtained from a user terminal is arranged in a user occupied area of the corresponding user. Further, when data is transmitted/received between two or more users, an operation may be executed such that an operated object is moved between the user occupied areas of the users. FIG. 22 shows how user A copies an operated object held by user B in user occupied area B onto user occupied area A. Alternatively, an operated object may be divided rather than copied.

An operated object copied on the screen simply provides an independent another piece of data if the copied operated object is content such as a moving image or a still image. If a copied operated object is the window of an application, this copied operated object provides another window of an application that may be collaboratively operated between the user originally having the operated object and the user having the copied operated object.

### (C) Optimum Selection of Input Means and Display GUI Corresponding to User Positions

The information processing apparatus 100 has the distance sensor 507 and the proximity sensor 511 as described before and therefore can detect the distance from the information processing apparatus 100 main body or the screen to a user in the wall-mounted state as shown in FIG. 1 and FIG. 3, for example.

In addition, the information processing apparatus 100 has the touch detection block 509, the proximity sensor 511, the camera block 503, and the remote control reception block 501 as described before and therefore can provide the user with two or more input means such as touch on the screen, proximity to the screen, gesture with a hand or the like, a remote controller, and an indirect operation based on a user state. Each of these input means depends in operation on the distance from the information processing apparatus 100 main body or the screen to the user. For example, if the user is within 50 centimeters from the information processing apparatus 100 main body, the user can directly touch the screen to surely operate an operated object. If the user is within two meters from the information processing apparatus 100 main body, it is too far for the user to directly touch the screen but the user can correctly capture the movement of the face or the hand of the user by executing recognition processing on an image taken with the camera block 503, thereby allowing gesture input. Further, the user is apart from the information processing apparatus 100 main body by two meters or more, a remote control signal surely reaches the information processing apparatus 100 main body even if the precision of image recognition lowers, so that an operation with a remote controller is realized. In addition, optimum GUI display such as the framework and information density of an operated object to be displayed on the screen also depends on the distance between the information processing apparatus 100 main body and the user.

In the present embodiment, one of the input means is automatically selected in accordance with the position of the user or the distance between the information processing apparatus 100 main body and the user, and GUI display is automatically selected or adjusted in accordance with the position of the user, thereby enhancing user convenience.

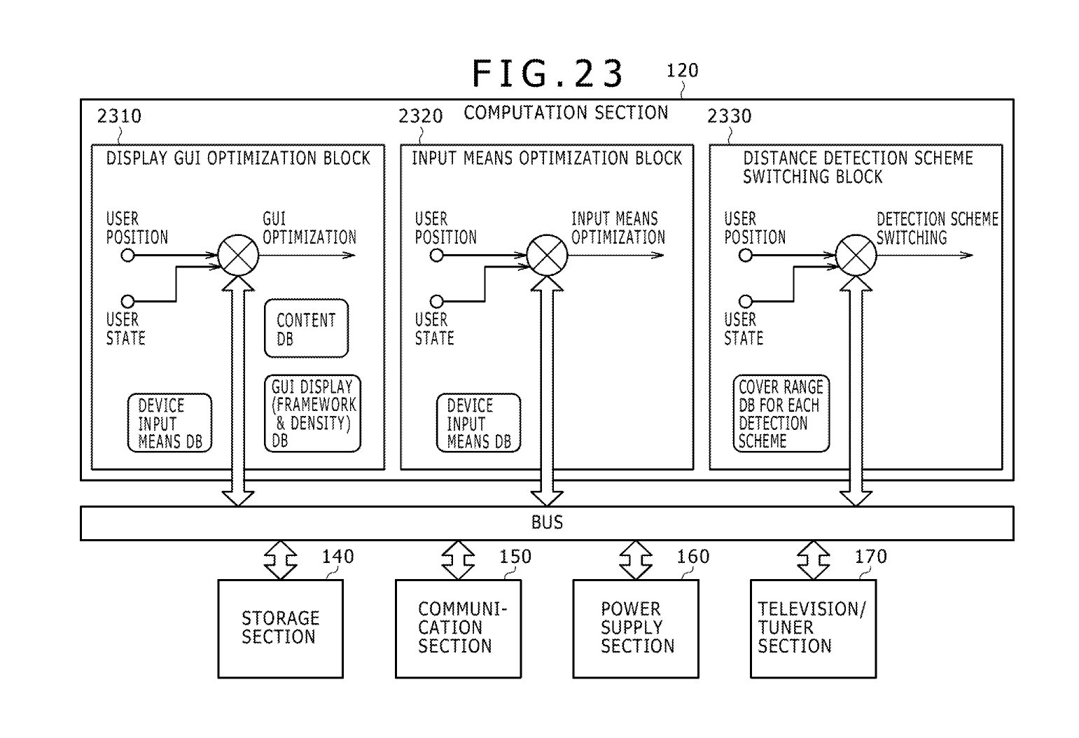

FIG. 23 shows an exemplary internal configuration for the computation section 120 to execute optimization processing in accordance with the distance between the information processing apparatus 100 and the user. The computation section 120 has a display GUI optimization block 2310, an input means optimization block 2320, and a distance detection scheme switching block 2330.

The display GUI optimization block 2310 executes optimization processing on GUI display such as the framework and information density of an operated object to be displayed on the screen of the display block 603 in accordance with the position and state of the user.

The position of the user can be obtained by a distance detection scheme switched from other schemes by the distance detection scheme switching block 2330. When the user gets closer to the screen, personal authentication can be realized by the face recognition of an image taken with the camera block 503 or the proximity communication with a terminal held by the user, for example. The state of the user is identified by the image recognition of an image taken with the camera block 503 or the signal analysis of the distance sensor 507. The state of the user is one of the two; “user is present” and “user is not present.” “User is present” state is one of the two; “user is viewing the television (or the screen of the display block 603)” and “user is not viewing the television (non-viewing).” Further, “user is viewing the television” state is one of the two; “the user is operating the television (operating)” and “the user is not operating the television (no operation).”

In the determination of a user state, the display GUI optimization block 2310 references a device input means database in the storage section 140. In addition, in accordance with a determined user position and user state, the display GUI optimization block 2310 references a GUI display (framework and density) database and a content database in the storage section 140 in optimizing display GUI.

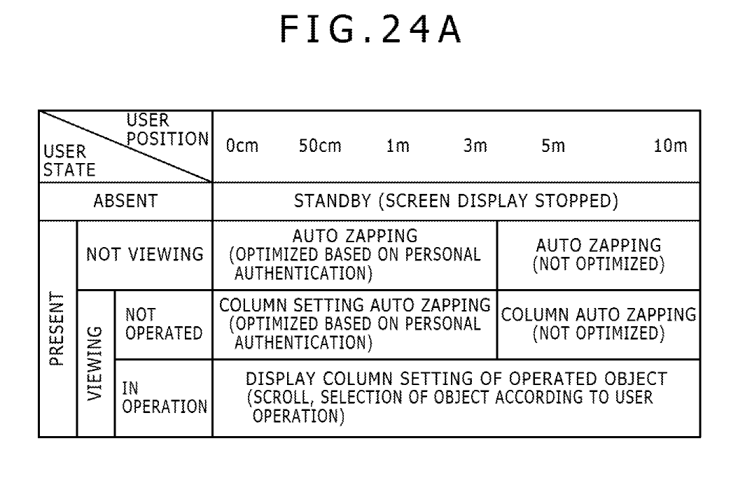

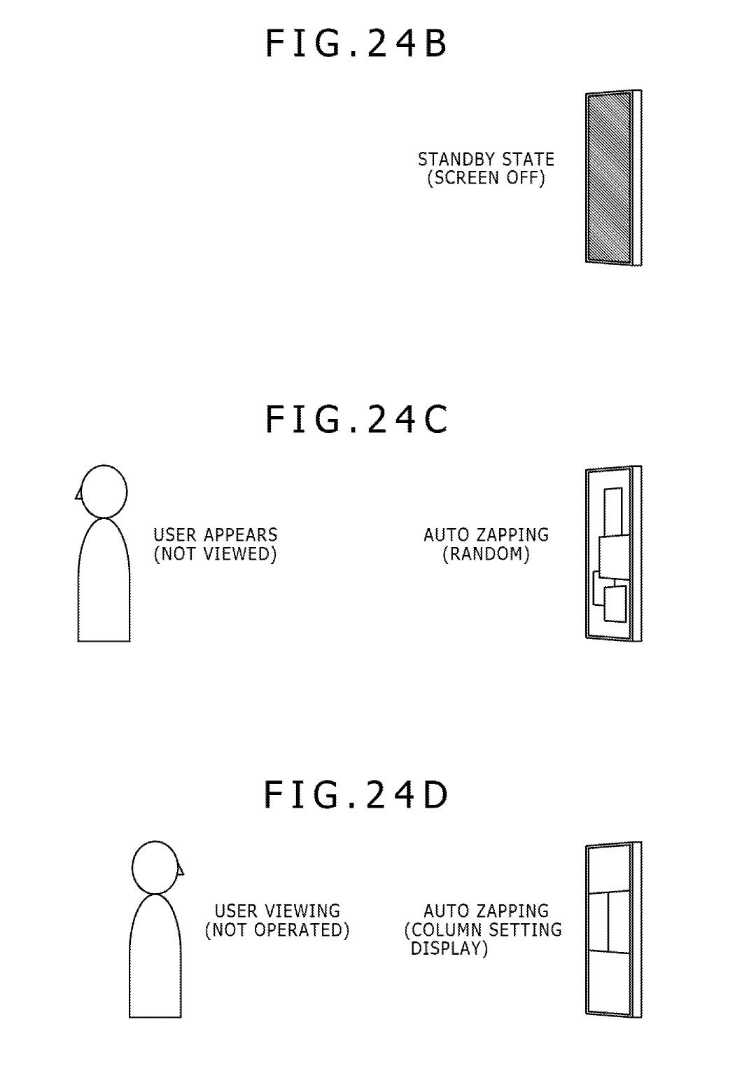

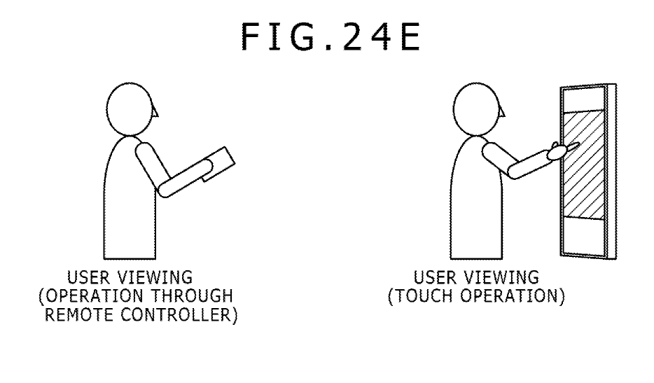

FIG. 24A is a table in which display GUI optimization processing operations to be executed in accordance with user position and user state by the display GUI optimization block 2310 are shown. FIG. 24B through FIG. 24E show screen transitions of the information processing apparatus 100 that take place in accordance with user position and user state.

In “user is not present” state, the display GUI optimization block 2310 stops the screen display of the display block 603 and waits until the presence of the user is detected (refer to FIG. 24B).

If “user is present,” but “user is not viewing the television,” then the display GUI optimization block 2310 selects “auto zapping” as optimum display GUI (refer to FIG. 24C). Auto zapping displays various operated objects in a random manner to attract user's interest, thereby making the user desire to view television programs. The operated objects for use by auto zapping include such operated objects selected by the display GUI optimization block 2310 on the basis of the content database as network content downloaded from the Internet through the communication section 150 and the mail and messages received from other users in addition to television broadcast program content received at the television/tuner section 170.

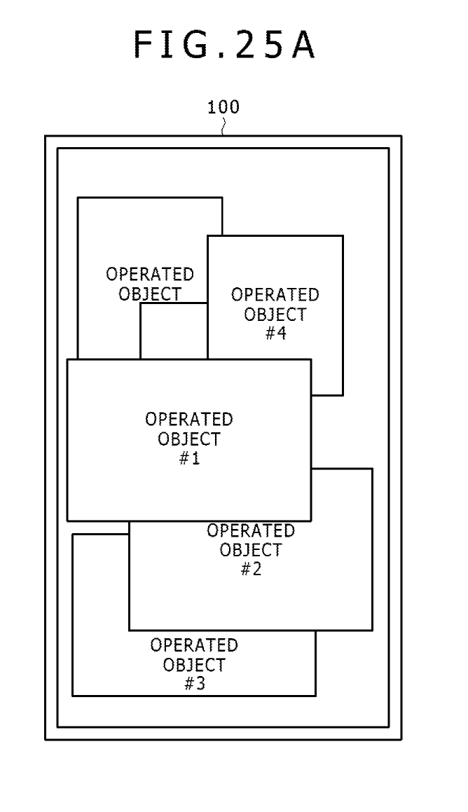

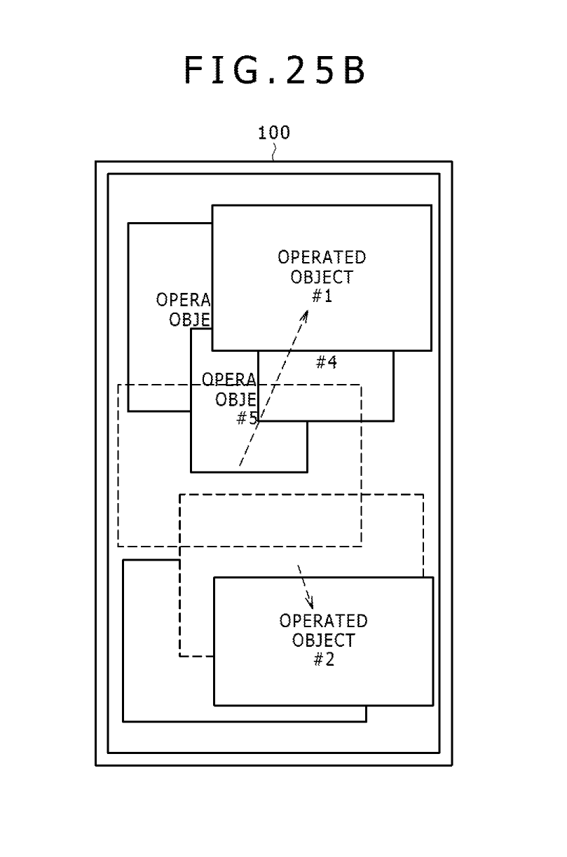

FIG. 25A shows an exemplary display GUI in which auto zapping is executed. The display GUI optimization block 2310 may vary the position and size (namely, the degree of exposure) of each operated object to be displayed on the screen from time to time as shown in FIG. 25B, thereby working on user's subconsciousness. Further, if the user position gets closer to the screen, allowing personal authentication, then the display GUI optimization block 2310 may select or discard operated objects to be auto-zapped by use of the identified personal information.

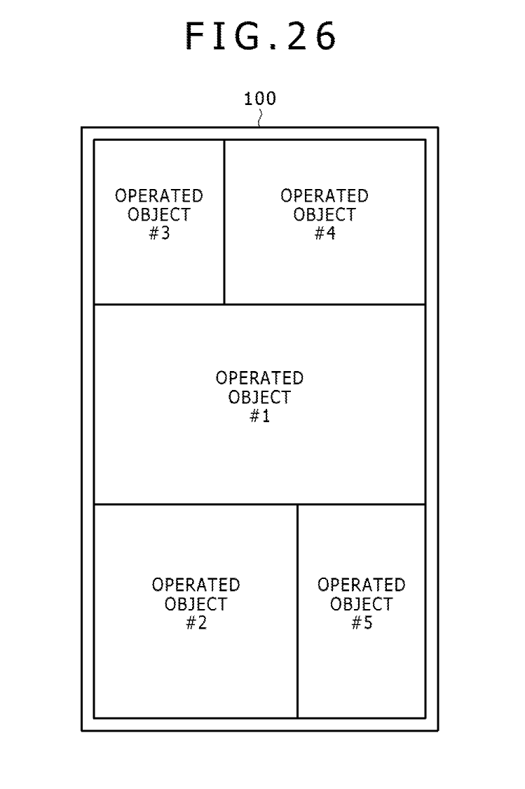

If “user is viewing the television” but “the user is not operating the television,” then the display GUI optimization block 2310 selects “auto zapping” as optimum display GUI (refer to FIG. 24D). It should be noted however that, unlike the above-mentioned example, two or more operated objects selected on the basis of the content database are regularly arranged by stacking as described in FIG. 26, thereby facilitating the checking of the display contents of each individual operated object. In addition, if the user position gets closer to the screen to allow personal authentication, then the display GUI optimization block 2310 may select or discard operated objects to be auto-zapped by use of the identified personal information. Further, the display GUI optimization block 2310 may control the information density of display GUI in accordance with the position of user such that the information density of display GUI is suppressed when the user is relatively away from the screen, and the information density of display GUI is increased when the user gets closer to the screen, for example.

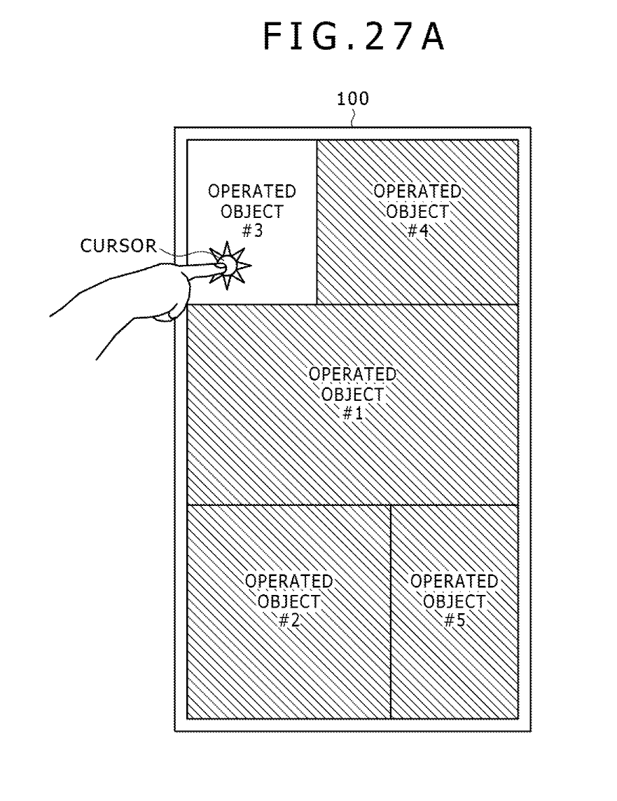

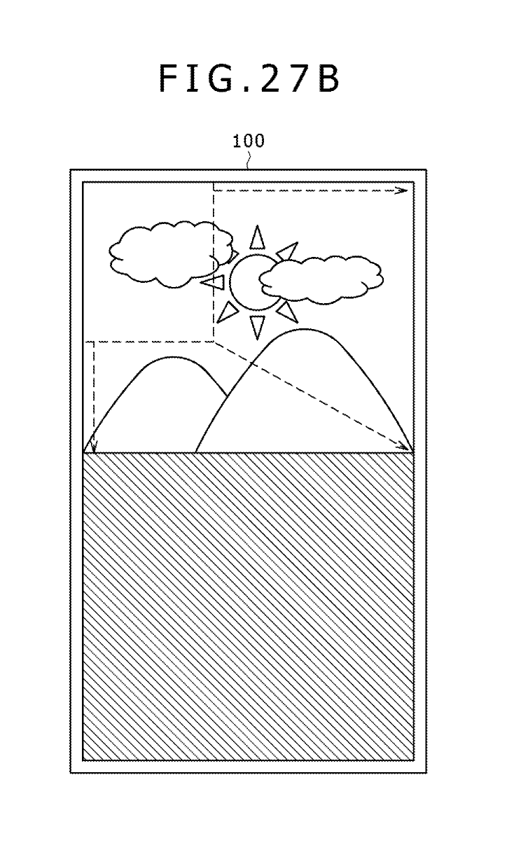

On the other hand, if “user is viewing the television” and “the user is operating the television” at the same time, it indicates that the user is operating the information processing apparatus 100 by use of the input means optimized by the input means optimization block 2320 (refer to FIG. 24E). The input means include the transmission of remote control signal to the remote control reception block 501, the gesture to the camera block 503, touch on the touch panel that is detected by the touch detection block 509, the input of audio into the microphone block 505, and the proximity input into the proximity sensor 511, for example. The display GUI optimization block 2310 can display operated objects in a stack as optimum display GUI in accordance with an input operation done by the user, thereby executing operations for scrolling and selecting an operated object in accordance with an operation done by the user. A cursor is displayed at a position on the screen indicated through the selected input means as shown in FIG. 27A. Operated objects at which the cursor is not positioned are considered to be the operated objects not in user attention, so that the luminance level of these operated objects may be lowered as indicated by hatches shown in the figure to provide contrast difference from the operated object of user attention (in the figure, the cursor is positioned at operated object #3 touched by the finger of the user). In addition, as shown in FIG. 27B, it is also practicable that, when the user selects an operated object at which the cursor is positioned, the selected operated object is displayed in full screen (or zoomed in to a possible maximum size) (in the figure, selected operated object #3 is displayed in a zoom-in manner).

The input means optimization block 2320 optimizes input means through which a user operates the information processing apparatus 100 in accordance with user position and user state.

As described before, the position of a user is obtained by a distance detection scheme selected by the distance detection scheme switching block 2330. When the user gets closer to the screen, the face recognition of an image taken with the camera block 503 and personal authentication through proximity communication with a terminal held by the user are made executable. The state of a user is identified on the basis of the image recognition of an image taken with the camera block 503 and the signal analysis of the distance sensor 507.

The input means optimization block 2320 references a device input means database in the storage section 140 in the determination of a user state.

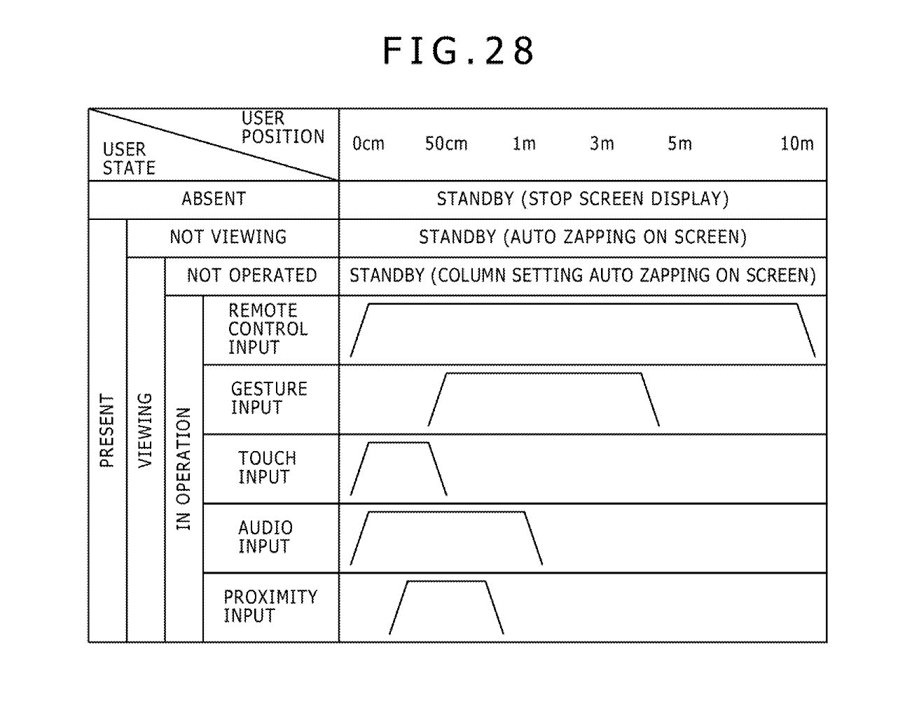

FIG. 28 shows the optimization processing of input means executed by the input means optimization block 2320 in accordance with user position and user state.

In “user is not present” state, “user is present” but “user is not viewing the television” state, and “user is viewing the television” but “user is not operating the television” state, the input means optimization block 2320 waits until an operation by the user starts.

Then, in “user is viewing the television” state and “user is operating the television” state, the input means optimization block 2320 optimizes each input means mainly in accordance with the position of the user. The input means include remote control input into the remote control reception block 501, gesture input into the camera block 503, touch input detected by the touch detection block 509, audio input into the microphone block 505, and proximity input into the proximity sensor 511, for example.

The remote control reception block 501 is activated for all user positions (namely, always active) to wait for the reception of a remote control signal.

The recognition accuracy for an image taken with the camera block 503 lowers as a user gets farther away from the screen. On the other hand, if a user gets closer to the screen too much, the figure of the user tends to get out of the imaging scope of the camera block 503. Therefore, the input means optimization block 2320 turns on the gesture input into the camera block 503 when the position of user gets in a range of several tens centimeters to several meters from the screen.

The touch onto the touch panel superimposed with the screen of the display block 603 is restricted to a range in which the hand of a user can reach. Therefore, the input means optimization block 2320 turns on the touch input into the touch detection block 509 when the position of a user gets in a range up to several tens centimeters from the screen. The proximity sensor 511 can detects a user in a range up to several tens centimeters if the user is not touching the touch panel. Therefore, the input means optimization block 2320 turns on proximity input up to a user position farther than touch input.

The recognition accuracy of audio input into the microphone block 505 lowers as a user gets away from the screen. Therefore, the input means optimization block 2320 turns on gesture input into the camera block 503 in a range of up to several meters of user position.

The distance detection scheme switching block 2330 causes the information processing apparatus 100 to switch between the schemes of detecting the distance up to a user and the position of the user in accordance with user position.

In the determination of a user state, the distance detection scheme switching block 2330 references a cover range database for each detection scheme in the storage section 140.

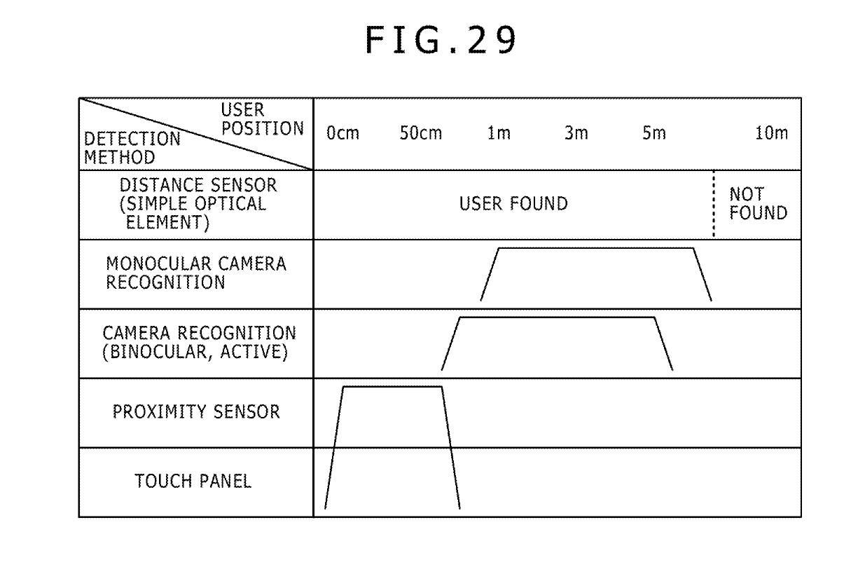

FIG. 29 shows a table in which switching processing operations to be executed in accordance with user position by the distance detection scheme switching block 2330 are shown.

The distance sensor 507 is made up of a simple and low power dissipation sensor element, such as a PSD sensor, a pyroelectric sensor, or a simplified camera, for example. In order to always monitor the presence of a user within the radius of five to ten meters from the information processing apparatus 100, the distance detection scheme switching block 2330 always turns on the distance sensor 507.

If the camera block 503 is of a monocular type, the image recognition block 504 executes user movement recognition, face recognition, and human body recognition, for example on the basis of background difference. The distance detection scheme switching block 2330 turns on the recognition (or distance detection) function by the image recognition block 504 when user position is within a range of 70 centimeters to six meters with which a sufficient recognition accuracy can be obtained on the basis of a taken image.

If the camera block 503 is of a binocular type or an active type, the image recognition block 504 can get a sufficient recognition accuracy in a range of 60 centimeters to five meters, which is slightly nearer to the screen than the monocular type camera mentioned above. The distance detection scheme switching block 2330 turns on the recognition (or distance detection) function by the image recognition block 504 in this range of user position.

If a user gets closer to the screen too much, the figure of the user tend to get out of the scope of the camera block 503. Therefore, if a user gets closer the screen too much, the distance detection scheme switching block 2330 may turn off the camera block 503 and the image recognition block 504.

The touch onto the touch panel superimposed with the screen of the display block 603 is restricted to a range in which the hand of a user can reach. Therefore, the distance detection scheme switching block 2330 turns on the distance detection function by the touch detection block 509 in a range up to several tens centimeters of user position. The proximity sensor 511 can detect a user up to several centimeters if a user is not touching the touch panel. Therefore, the distance detection scheme switching block 2330 turns on the distance detection function up to a user position farther than touch input.

In the design policy of the information processing apparatus 100 having two or more distance detection schemes, a distance detection scheme for executing detection in a relatively remote area exceeding several meters or ten meters must be always turned on for the recognition of the presence of a user. Therefore, it is desirable for this distance detection scheme to use a detection device of lower power dissipation. By contrast, a distance detection scheme for detecting a proximity distance of one meter or less can obtain information of high density to have recognition functions such as face recognition and human body recognition at the cost of relatively large power dissipation for recognition processing. Therefore it is desirable for this distance detection scheme to turn of these functions at distances where a sufficient recognition accuracy cannot be obtained.

### (D) Real-Size Display of Objects According to Monitor Performance

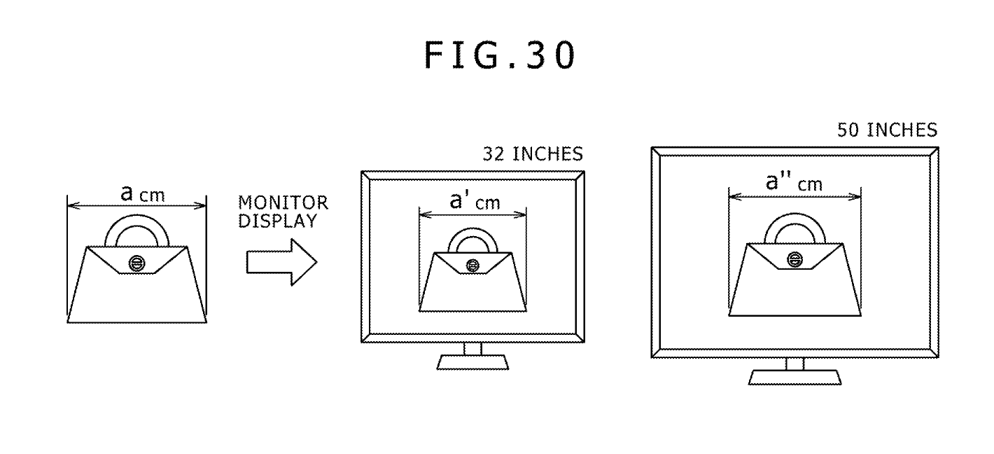

With related-art object display systems, an image of a real object is displayed on the screen without considering real-size information of that object. Therefore, the size of an object to be displayed in accordance with the size and resolution (dpi) of the screen fluctuates. For example, width “a′” obtained by displaying a bag having width of “a” centimeters on a 32-inch monitor screen is different from with “a″” obtained by displaying the same bag on a 50-inch monitor screen (“a” not equal to “a′” not equal to “a″”) (refer to FIG. 30).

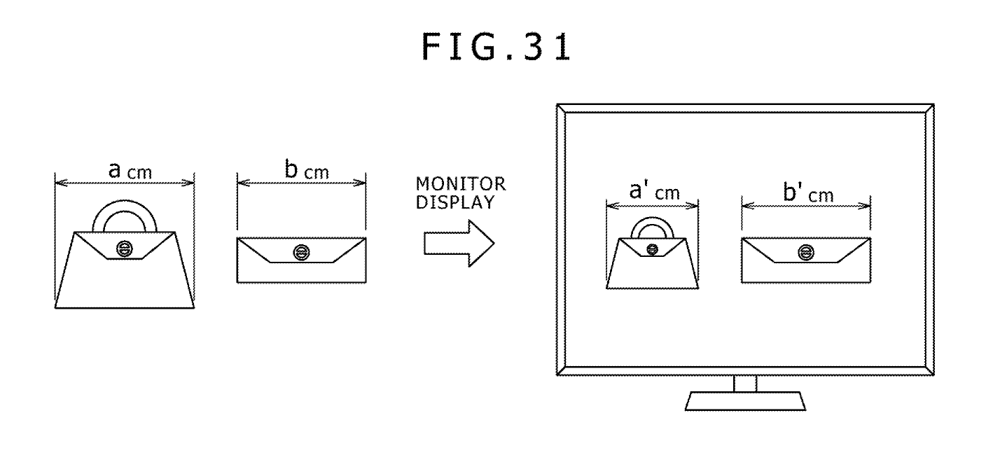

In simultaneous display of the images of two or more objects on the same monitor screen, the size relation between the objects cannot be correctly displayed unless the real-size information of each object is considered. For example, in simultaneously displaying a bag having width of “a” centimeters and a pouch having width of “b” centimeters on the same monitor screen, the width of the bag is displayed in “a′” centimeters while the width of the pouch is displayed in “b′” centimeters, the size relation between the bag and the pouch being not correctly displayed (“a”: “b” not equal to “a′”: “b′”) (refer to FIG. 31).

For example, in net-shopping a commercial product, a user cannot properly fit the commercial product to his or her figure unless the sample image of this commercial product is reproduced in real size, thereby making it likely for the user to purchase a wrong product. In simultaneously purchasing two or more commercial products by net shopping, a user cannot properly combine and fit the commercial products unless the size relation between the sample images is properly displayed when these sample images are simultaneously displayed on the screen, thereby making it likely for the user to purchase a wrong combination of commercial products.

Unlike the related-art technologies, the information processing apparatus 100 according to the present embodiment is configured to manage the real size information of objects to be displayed and the size and resolution (or pixel pitch) of the screen of the display block 603 to always ensure the displaying of the image of each object in real size on the screen even if the object size and/or screen size changes.

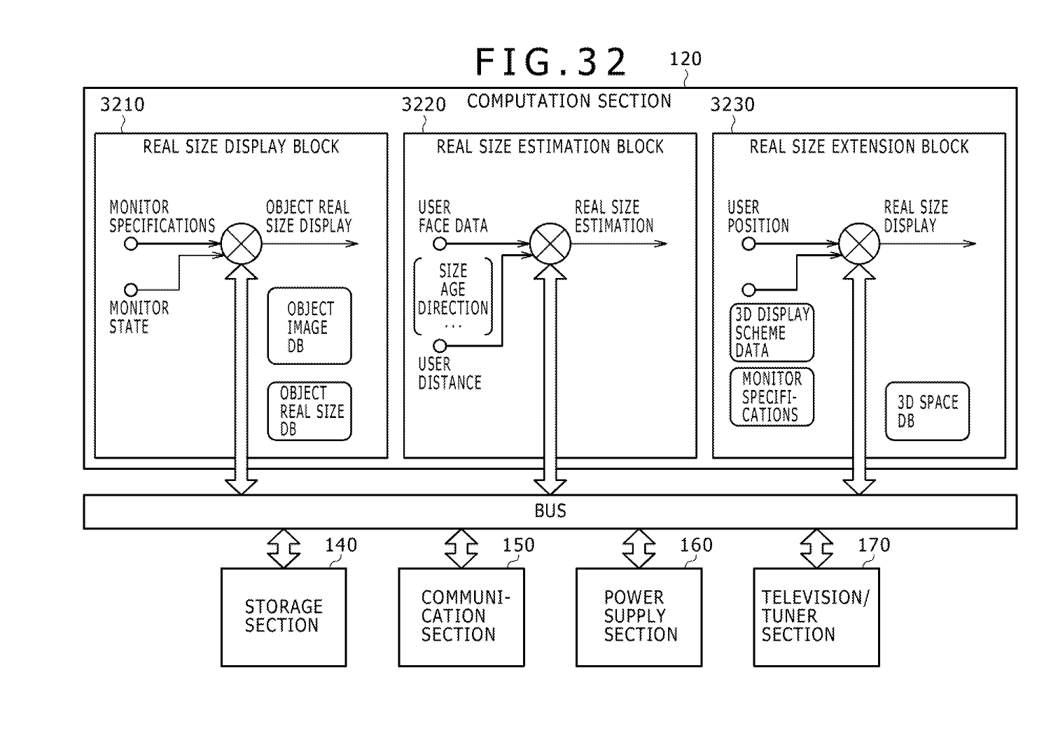

FIG. 32 shows an exemplary internal configuration for the computation section 120 to execute real size display processing of an object in accordance with monitor performance. The computation section 120 has a real size display block 3210, a real size estimation block 3220, and a real size extension block 3230. It should be noted that at least one functional block of the real size display block 3210, real size estimation block 3220, and the real size extension block 3230 may be assumed to be realized on a cloud server connected to the information processing apparatus 100 through the communication section 150.

In displaying the images of two or more objects on the same monitor screen, the real size display block 3210 considers the real size information of each of the objects to always display the images of objects in real size in accordance with the size and resolution (or pixel pitch) of the screen of the display block 603. In addition, in simultaneously displaying the images of two or more objects on the screen of the display block 603, the real size display block 3210 correctly displays the size relation between these objects.

The real size display block 3210 reads monitor specifications such as the size and resolution (or pixel pitch) of the screen of the display block 603 from the storage section 140. In addition, the real size display block 3210 obtains monitor states such as the direction and tilt of the screen of the display block 603 from the rotation/mount mechanism block 180.

Further, the real size display block 3210 reads the images of objects to be displayed from an object image database in the storage section 140 and, at the same time, the real size information of these objects from the object real size database in the storage section 140. It should be noted that the object image database and the object real size database may be assumed to be located on a database server connected to the information processing apparatus 100 through the communication section 150.

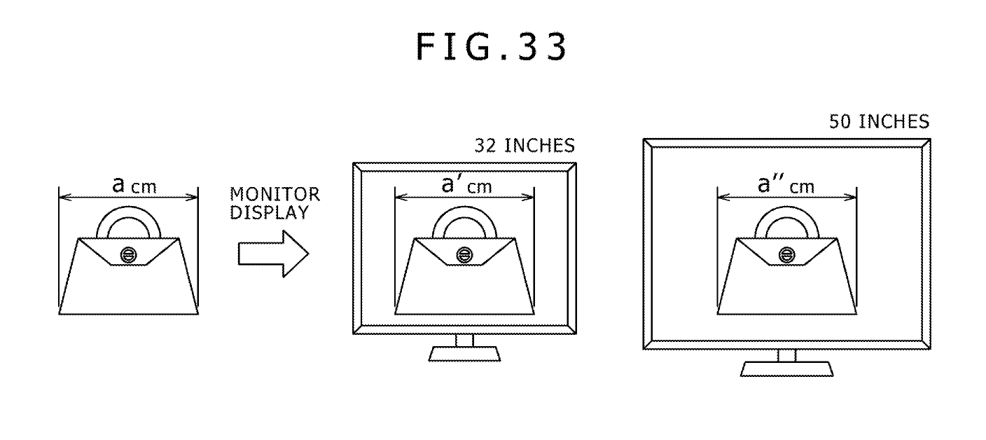

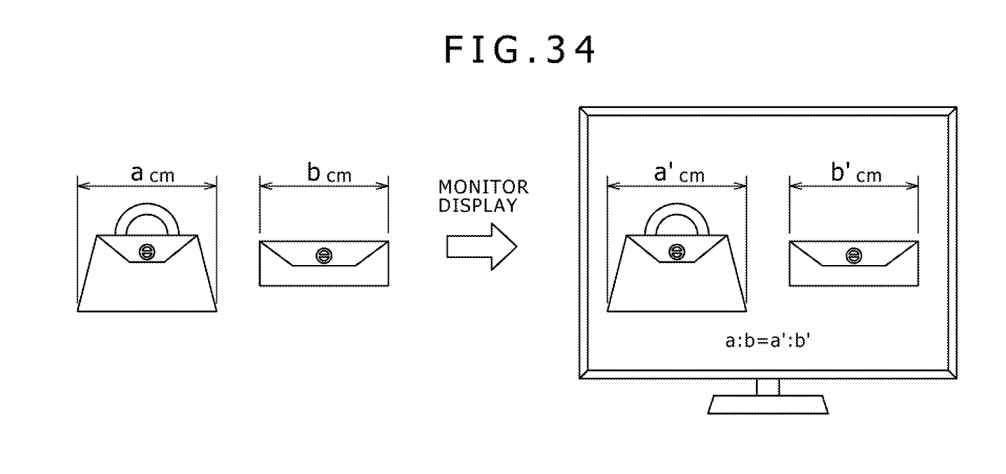

Then, the real size display block 3210 executes object image conversion processing such that an object to be displayed becomes real size on the screen of the display block 603 (or the size relation between two or more objects becomes correct) on the basis of monitor performance and monitor state. Namely, even if the image of a same object is displayed on the screens of different monitor specifications, relation “a” equal to “a′” equal to “a″” is obtained as shown in FIG. 33.

Further, in simultaneously displaying the images of two objects having different real sizes on the same screen, the real size display block 3210 ensures relation “a”: “b” equal to “a′”: “b′,” thereby correctly displaying the size relation between the two objects.

For example, when a user net-shops commercial products through the display of sample images, the information processing apparatus 100 can realize the real size display of objects and the correct size relation between two or more samples as described above, so that the user can execute correct fitting of commercial products, thereby minimizing the chance of purchasing wrong commercial products.

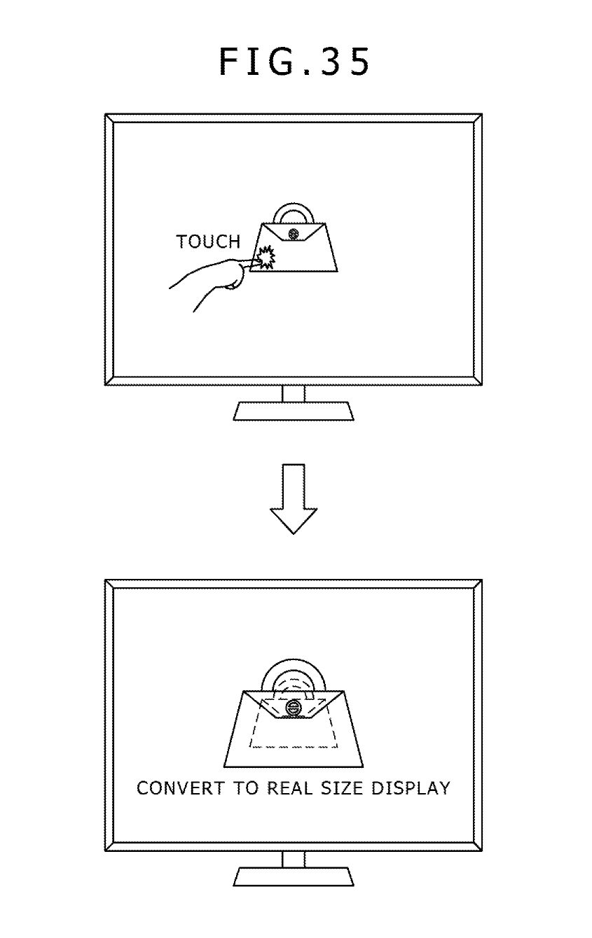

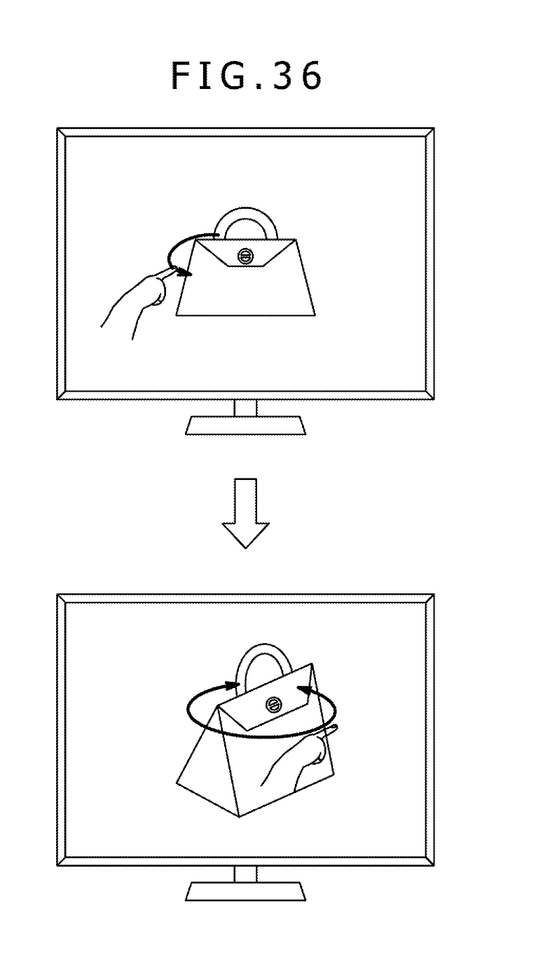

The following extends the description done above by use of an example in which the real size display of object mages in the real size display block 3210 is applied to a net shopping application. In response to the touching a desired commercial product by a user on a catalog display screen, the image of the touched commercial product is switched to real size display (refer to FIG. 35). In addition, in accordance with a touch operation by a user onto an image displayed in real size, the image may be rotated or changed in posture, thereby displaying the real size object with the direction thereof changed (refer to FIG. 36).

The real size estimation block 3220 executes the processing of estimating the real size of such an object of which real size information may not be obtained by referencing the object real size database as a person taken with the camera block 503. For example, if an object for which a real size is to be estimated is a user face, then the real size estimation block 3220 estimates the real size of the user on the basis of such user face data as the size, age, and direction of the user face obtained by recognizing an image taken with the camera block 503 and a user position obtained by a distance detection scheme selected by the distance detection scheme switching block 2330 from the image recognition block 504.

The estimated user real size information is fed back to the real size display block 3210 to be stored in an object image database for example. Then, the real size information estimated from the user face data is used for real size display in accordance with the subsequent monitor performance in the real size display block 3210.

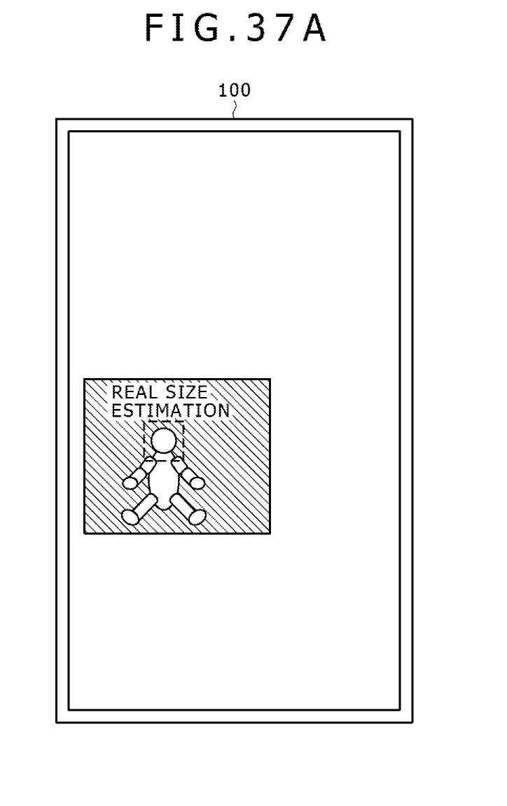

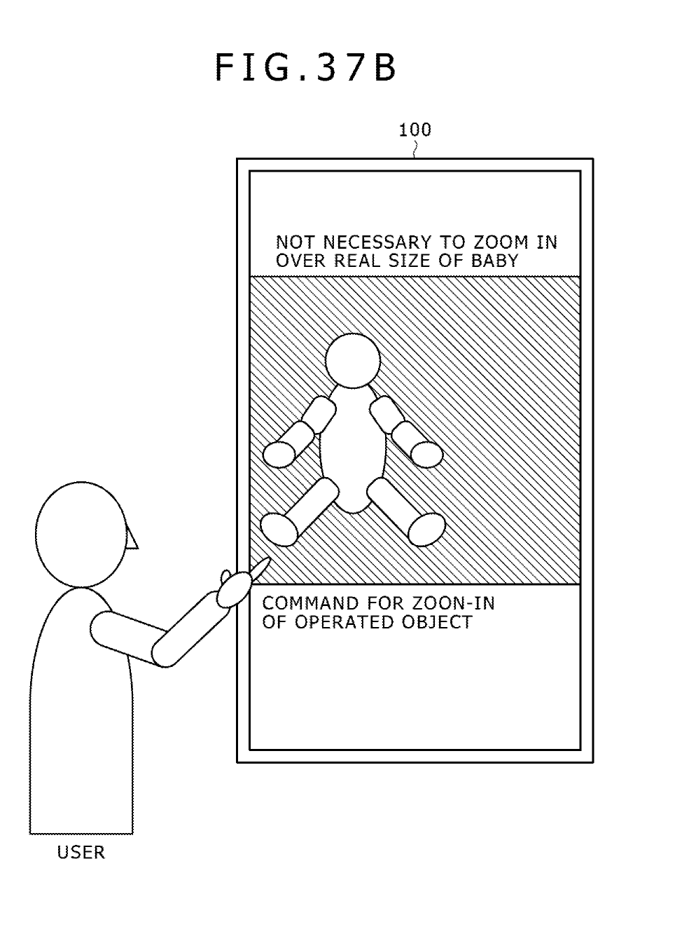

For example, as shown in FIG. 37A, when an operated object including a taken image of a subject (a baby), the real size estimation block 3220 estimates a real size on the basis of this face data. Then, if the user tries to enlarge this operated object by a touch operation, this operated object is not enlarged beyond the real size of the subject as shown FIG. 37B. Namely, the baby image is not enlarged unnaturally, thereby retaining the reality of video.

In addition, in displaying network content and content taken with the camera block 503 onto the display block 603 side by side or superimposed on each other, the content video may be normalized on the basis of the estimated real size to realize balanced parallel or superimposed display.

Further, the real size extension block 3230 realizes, in 3D (three dimension), namely, including the depth, the real size display of an object realized on the screen of the display block 603 in the real size display block 3210. It should be noted that, in the execution of 3D display on the basis of a binocular scheme or a light-ray reproduction scheme only in horizontal direction, desired effects may be obtained only at a viewing position supposed at the time of 3D video generation. In an omnidirectional light-ray reproduction scheme, real size display may be realized at any position.

In addition, in the binocular scheme or the light-ray reproduction scheme only in horizontal direction, the real size extension block 3230 may also detect a user viewing position to correct a 3D video by that position, thereby obtaining a similar real size from any position.

For example, refer to Japanese Patent Laid-open No. 2002-300602, Japanese Patent Laid-open No. 2005-149127, and Japanese Patent Laid-open No. 2005-142957 already assigned to the applicant hereof.

### (E) Simultaneous Display of an Image Group

In the display system, video content obtained from two or more sources may be simultaneously displayed on the same screen in a parallel or superimposed manner. For example; (1) in the case where two or more users execute video chat with each other, (2) in the case where, in a yoga lesson for example, a video of an yoga instructor reproduced from a recording media such as a DVD (or stream-reproduced via a network) and a video of the user taken with the camera block 503 are displayed at the same time, and (3) in the case where, in net shopping, a commercial product sample image and the video of the user taken with the camera block 503 are displayed in a superimposed manner for the purpose of fitting.

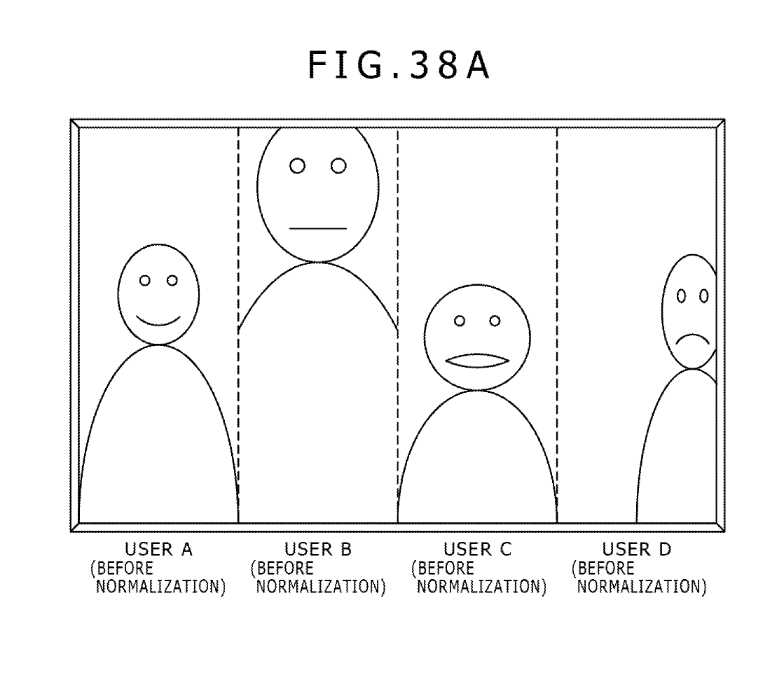

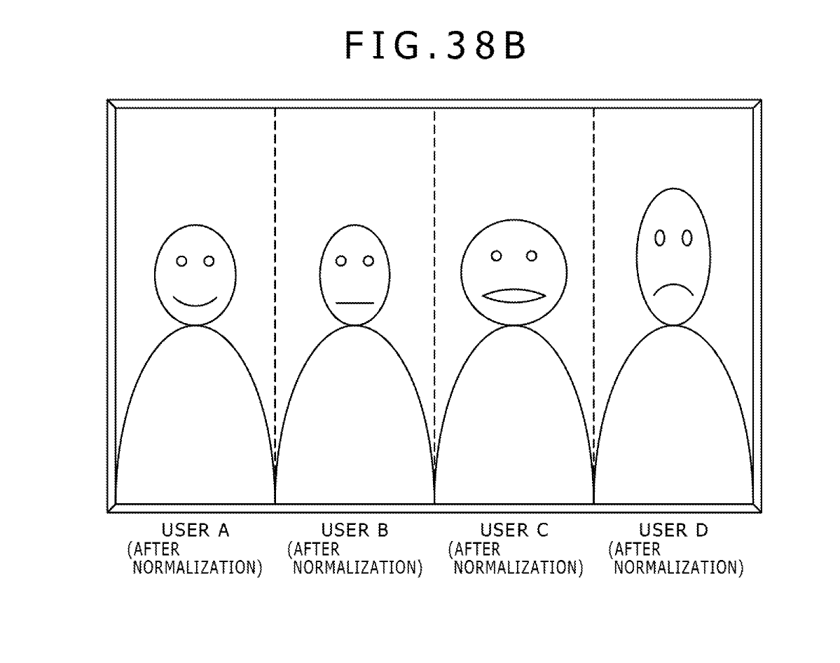

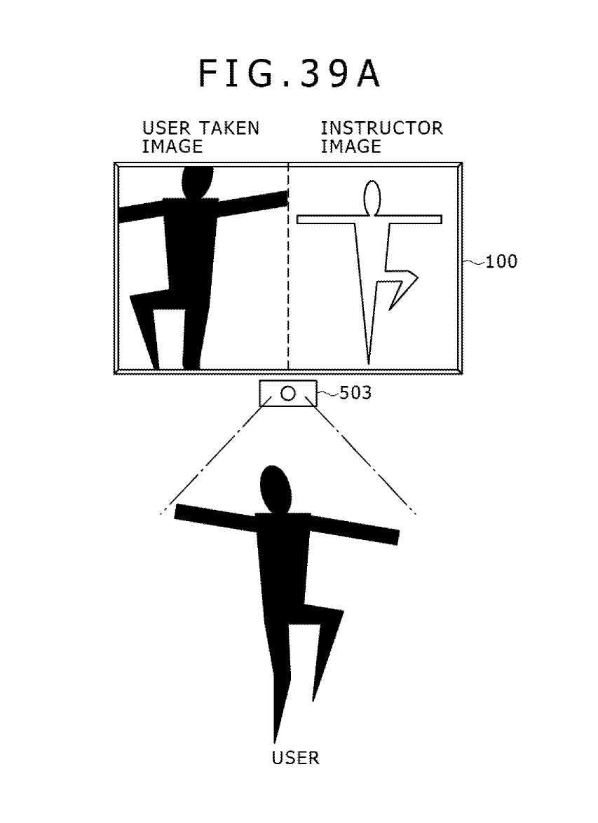

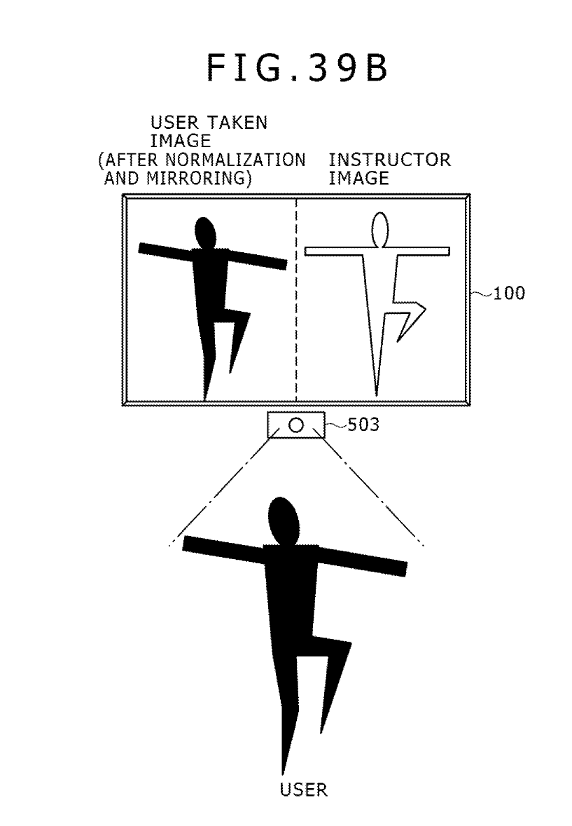

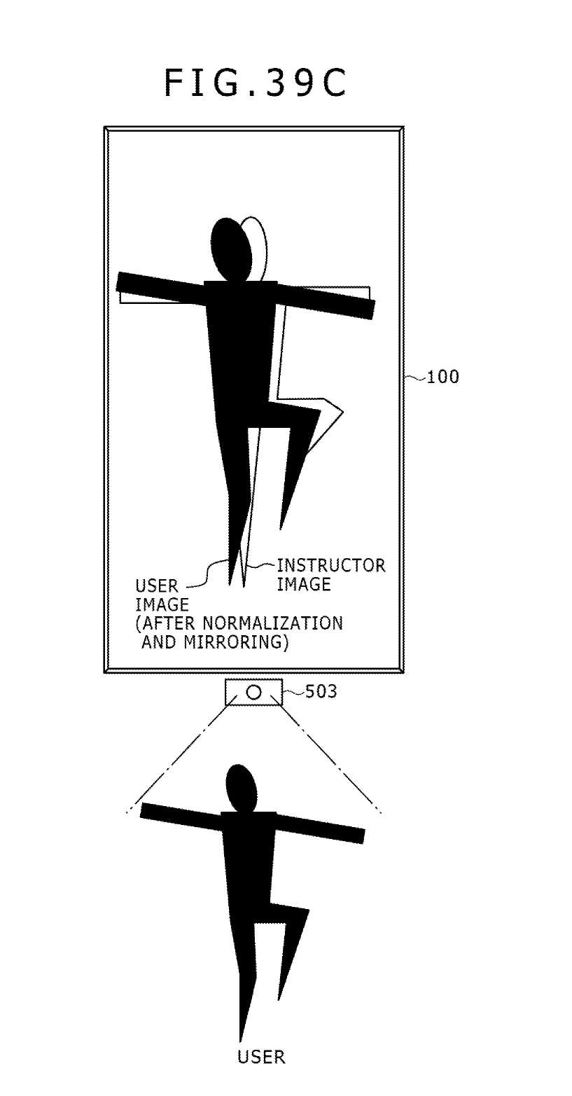

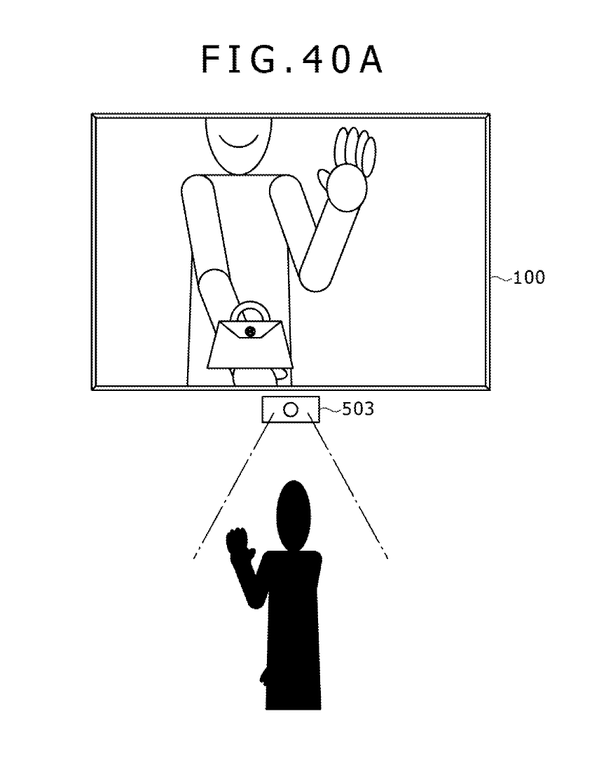

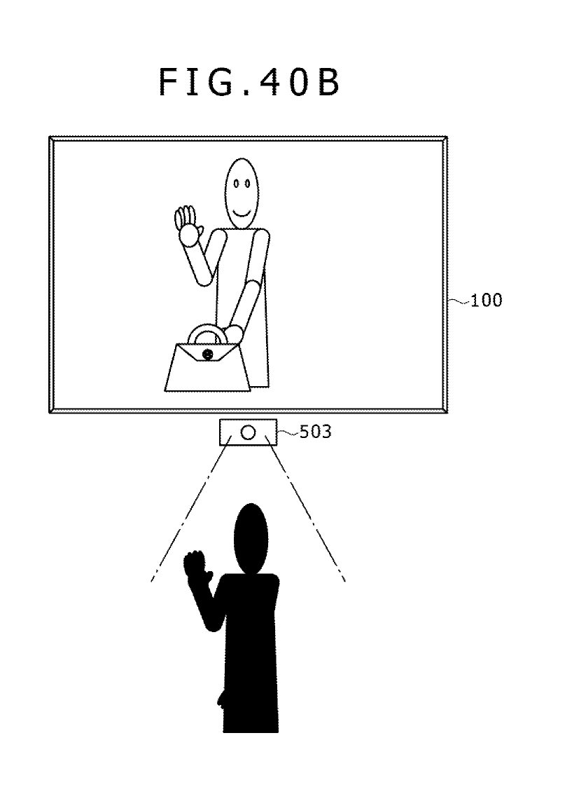

In each case of the (1) and (2) above, if the size relation between the images to be displayed at the same time is not correctly displayed, the user cannot properly use the displayed video. For example, if the size and position of faces of users executing a video chat become uneven (refer to FIG. 38A), the face-to-face virtual reality becomes impaired, thereby losing smooth flow of talk. In addition, if the sizes and positions of a user's figure and an instructor's figure are uneven (refer to FIG. 39A), it becomes difficult for the user to take the measure of the difference between own movement and instructor's movement, thereby being unable to understand the points of correction and improvement, leading unsatisfactory lesson effects. In addition, if a commercial product sample image is not superimposed on a proper position in the correct size relation between the commercial product sample image and the user video that is posed to take the commercial product, it becomes difficult for the user to check if this commercial product fits the user or not, thereby making it impossible to provide correct fitting (FIG. 40A).

On the other hand, in arranging the video content from two or more sources in parallel to each other or superimposing the video content from two or more sources on each other, the information processing apparatus 100 according to the present embodiment normalizes the images to display in a parallel or superimposed manner by use of the information such as image scale and corresponding area. In the normalization, such image manipulation is executed as digital zoom processing on digital image data including a still image and a moving image. In addition, if one of the images to be arranged in a parallel or superimposed manner is an image taken with the camera block 503, then the actual camera is optically controlled such as panning, tilting, and zooming.

The image normalization processing can be easily realized by use of such information as the size of face obtained by face recognition, age, and direction, and such information as the figure and size of body obtained by personal recognition. In addition, in arranging two or more images in a parallel or superimposed manner, mirroring and rotation are automatically executed on one of the images to facilitate correspondence with the other image.

FIG. 38B shows a manner in which the face sizes and positions of the users having video chat are made even by the normalization processing between two or more images. FIG. 39B shows a manner in which the sizes and positions of a user figure and an instructor's figure to be displayed on the screen in parallel to each other are evenly aligned by the normalization processing between two or more images. FIG. 40B shows a manner in which a commercial product sample image is displayed, by the normalization processing between two or more images, at a proper position as superimposed on the video of the user posing to take the commercial product in a proper size relation. It should be noted that, in FIG. 39B and FIG. 40B, in addition to the size-relation normalization processing, mirroring is also executed in order to facilitates correction of the user's posture from the image taken with the camera block 503. Rotation processing may also be executed as required. In addition, if a user figure can be normalized with an instructor's figure, the normalized figure can be superimposed on each other as shown in FIG. 39C, rather than arranging these figures in parallel to each other shown in FIG. 39B, thereby facilitating the user to further visually recognize a difference between user's posture and instructor's posture.

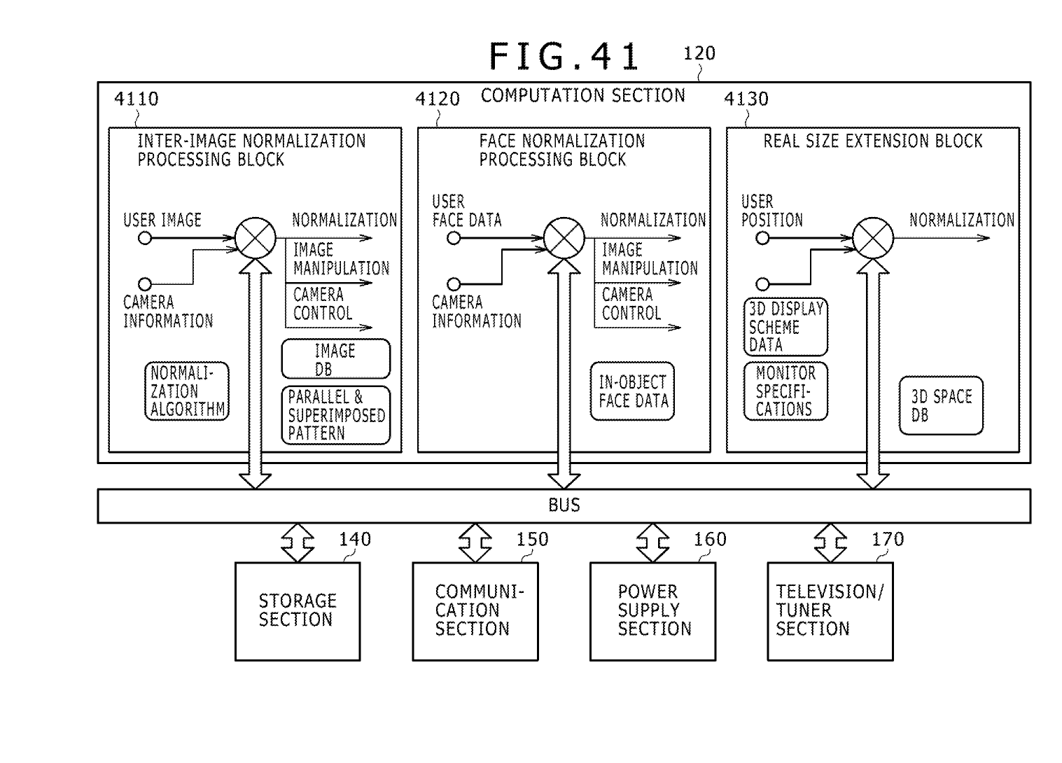

FIG. 41 shows an exemplary internal configuration for the computation section 120 to execute normalization processing on an image. The computation section 120 has an inter-image normalization processing block 4110, a face normalization processing block 4120, and a real size extension block 4130. It should be noted that at least one of the functional blocks, the inter-image normalization processing block 4110, the face normalization processing block 4120, and the real size extension block 4130 is supposed to be realized on a cloud server connected through the communication section 150.

The inter-image normalization processing block 4110 executes normalization processing such that the size relation between the image of a user and the image of another object is correctly displayed between two or more images.

The inter-image normalization processing block 4110 enters an image of user taken with the camera block 503 through the input interface integration block 520. In this processing, such camera information as panning, tilting, and zooming of the camera block 503 at the time of taking the user image is also obtained. In addition, the inter-image normalization processing block 4110 obtains the image of another object to be displayed in parallel to the user image or as superimposed on the user image and a pattern for displaying the user image and the image of another object in parallel or as superimposed on each other from an image database. The image database may be stored in the storage section 140 or a database server to be accessed through the communication section 150.

Then, the inter-image normalization processing block 4110 executes image manipulation such as zooming, rotation, and mirroring on the user image in accordance with a normalization algorithm such that the size relation with another object and the posture of the user image becomes appropriate. At the same time, in order to take an appropriate user image, camera control information is generated for controlling panning, tilting, and zooming of the camera block 503. The processing by the inter-image normalization processing block 4110 allows the user image to be displayed in the correct size relation with the image of another object as shown in FIG. 40B, for example.

The face normalization processing block 4120 executes normalization processing such that the size relation between the user's face image taken by the camera block 503 and the face image in another operated object (for example, an instructor's face in an image reproduced from a recording media or the face of a mate user of video chat) is appropriately displayed.

The face normalization processing block 4120 enters a user image taken with the camera block 503 through the input interface integration block 520. At the same time, such camera information as panning, tilting, and zooming of the camera block 503 at the time of taking a user image is obtained. In addition, the face normalization processing block 4120 obtains the face image in another operated object to be displayed in parallel to or as superimposed on a taken user's face image from the storage section 140 or through the communication section 150.

Next, the face normalization processing block 4120 executes image manipulation such as zooming, rotation, and mirroring on the user image such that the size relation between the user's face image and the face image in another object becomes appropriate. At the same time, in order to take an appropriate user image, camera control information is generated for controlling panning, tilting, and zooming of the camera block 503. The processing by the face normalization processing block 4120 allows the user's face image to be displayed in the correct size relation with the face image in another object as shown in FIG. 38B, FIG. 39B, and FIG. 39C, for example.

Further, the real size extension block 4130 realizes the parallel or superimposed display of two or more images realized in the inter-image normalization processing block 4110 or on the screen of the display block 603 in the inter-image normalization processing block 4110, in 3D, namely, the display including depth. It should be noted that, in the execution of 3D display on the basis of a binocular scheme or a light-ray reproduction scheme only in horizontal direction, desired effects may be obtained only at a viewing position supposed at the time of 3D video generation. In an omnidirectional light-ray reproduction scheme, real size display may be realized at any position.

In addition, in the binocular scheme or the light-ray reproduction scheme only in horizontal direction, the real size extension block 4130 may also detect a user viewing position to correct a 3D video by that position, thereby obtaining a similar real size display from any position.

For example, refer to Japanese Patent Laid-open No. 2002-300602, Japanese Patent Laid-open No. 2005-149127, and Japanese Patent Laid-open No. 2005-142957 already assigned to the applicant hereof.

### (F) Method of Displaying Video Content on Rotary Screen

As described before, the information processing apparatus 100 main body associated with the present embodiment is rotatably and detachably mounted on the wall with the rotation/mount mechanism block 180 for example. When the information processing apparatus 100 is rotated with power being on, that is, with an operated object being displayed on the display block 603, the operated object is rotated so as to allow the user to observe the operated object in a correct posture.

The following describes a method of optimally adjusting the display forms of video content with respect to a given rotational angle of the information processing apparatus 100 main body and the transition process of rotating.

The display forms of video content at a given rotational angle and in the transition process of rotating of the screen include (1) a display form in which video content is totally viewable at a given rotational angle, (2) a display form in which video content in focus is maximized in size at each rotational angle, and (3) a display form in which video content is rotated in order to remove an invalid area.

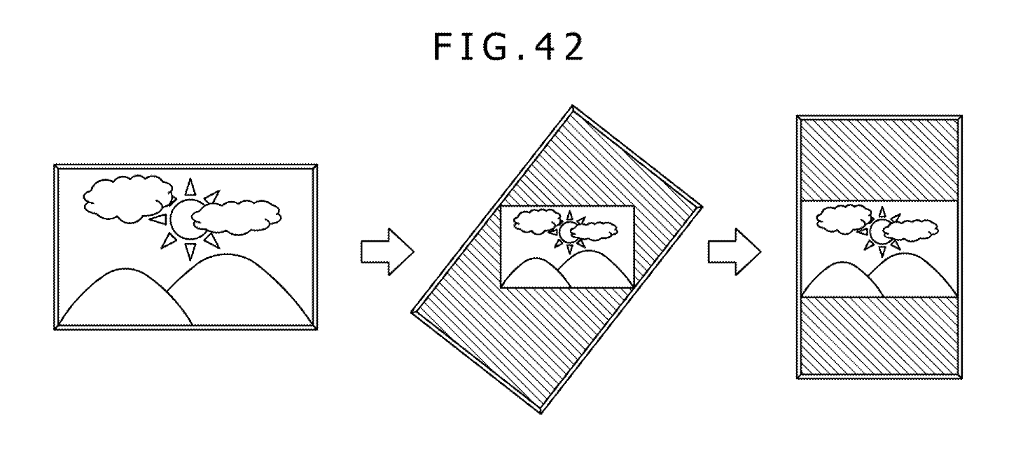

FIG. 42 illustrates a display form in which all areas of video content are displayed such that the video content is not cut at any given angle while rotating the information processing apparatus 100 (or the screen thereof) by 90 degrees counterclockwise. As shown, when video content in landscape display arrangement is shown on the screen in horizontal display arrangement, attempting to rotate the screen by 90 degrees counterclockwise to put the screen in vertical display arrangement shrinks the displayed video content and, at the same time, provides an invalid area indicated in black. In the process of putting the screen from horizontal display arrangement to vertical display arrangement, the display video content is minimized in size.

If at least a part of video content is cut from view, there occurs a problem that the video content as a copyrighted work loses identity. The display form shown in FIG. 42 is always ensured in identity as a copyrighted work at any given rotational angle or in the process of rotating. Namely, the display form shown in FIG. 42 is suitable for copyright-protected content.

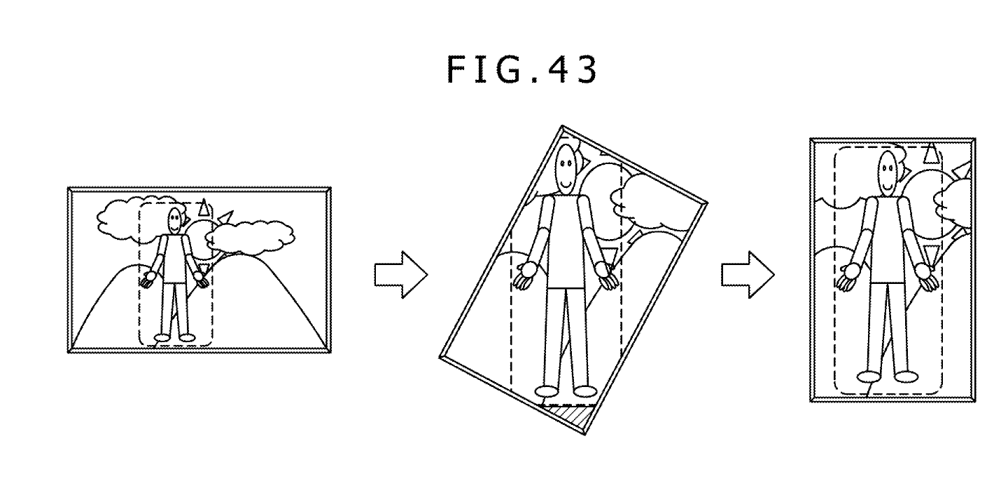

FIG. 43 illustrates a display form in which a focus area in video content is maximized at any given rotational angle while the information processing apparatus 100 (or the screen thereof) is rotated by the 90 degrees. In the figure, an area including a subject enclosed by dashed lines in the video content is set to a focused area to maximize this focused area at any given rotational angle. Because the focused area is portrait display, the video content is enlarged by putting the screen from the landscape display to portrait display. The focused area is maximized diagonally on the screen in the process of putting the screen from landscape display to portrait display. In the transition process of putting the screen from horizontal display to vertical display, an invalid area indicated by black appears on the screen.

A variation is possible as a display form with a focused area in a video content taken up, in which the video content is rotated with the size of a focused area kept constant. In this variation, as the screen rotates, the focused area looks smoothly rotating, but an invalid area increases.

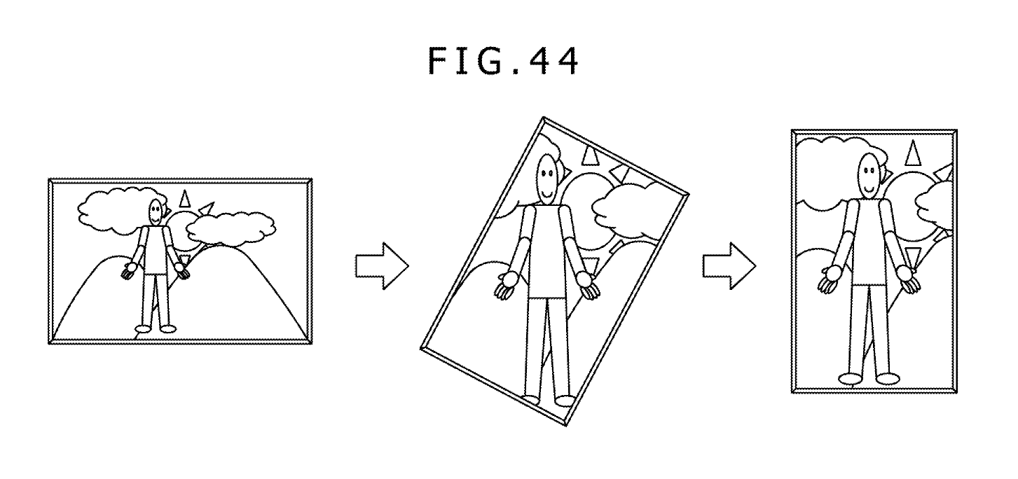

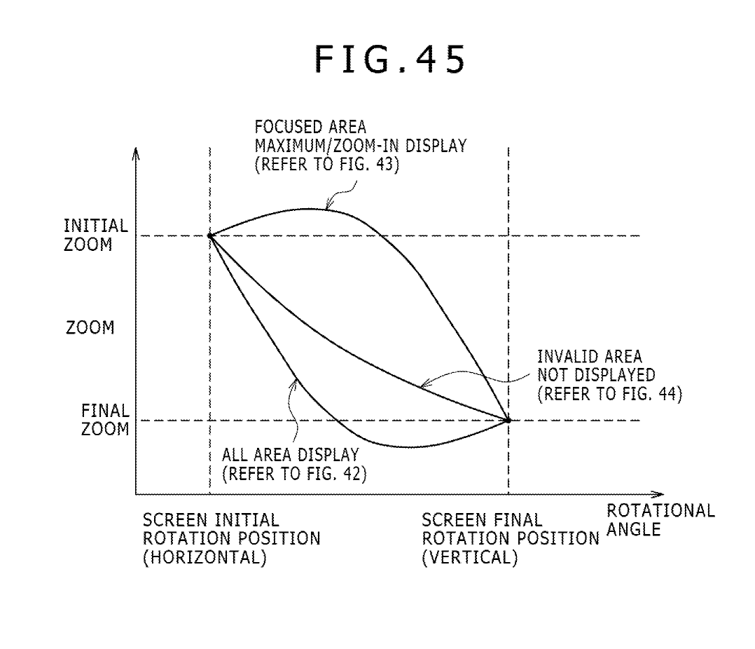

FIG. 44 shows a display form in which video content is rotated without causing an invalid area while the information processing apparatus 100 (or the screen thereof) is rotated by 90 degrees counterclockwise.

FIG. 45 shows a relation of zoom ratios of video content relative to rotational positions in each of the display forms shown in FIG. 42 through FIG. 44. In the display form shown in FIG. 42 in which video content is not cut from view at any given rotational angle, the copyright of the video content can be protected but a relatively large invalid area occurs in the transition process of rotating. In addition, because the video content gets smaller in the transition process of rotating, the user may have the feeling of unnaturalness in the transition process. In the display form shown in FIG. 43 in which the focused area of video content is maximized at any given rotational angle, the focused area can be rotated more smoothly, but an invalid area appears in the transition process of rotating. In the display form shown in FIG. 44, no invalid area occurs in the transition process of rotating, but the video content is largely extended in the transition process, thereby possibly making the observing user feel unnaturalness.

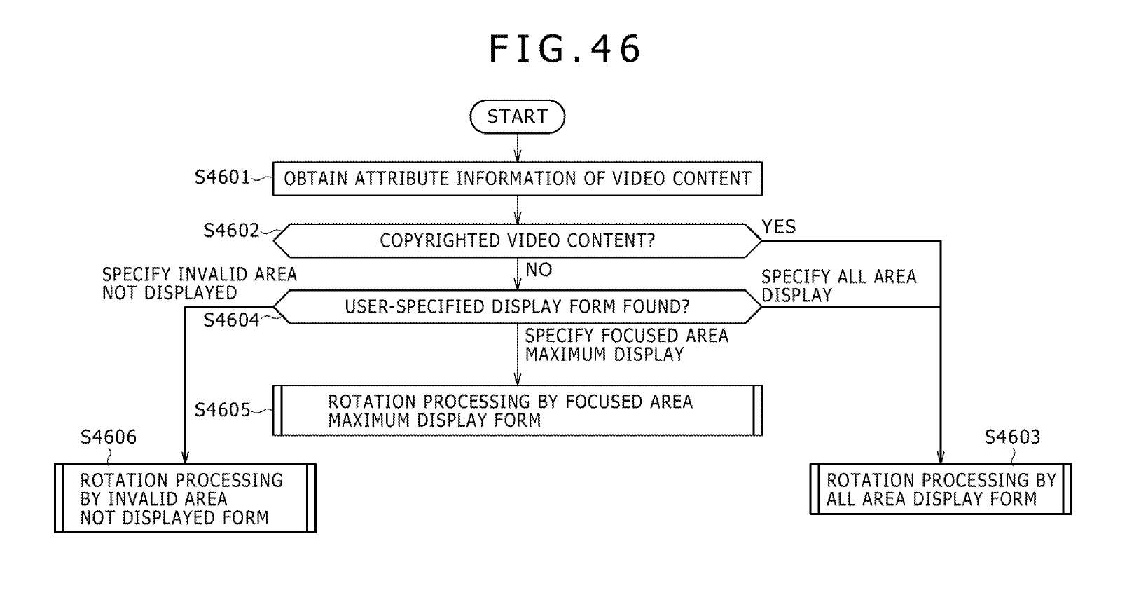

FIG. 46 shows a processing procedure in the form of a flowchart for controlling video content display forms by the computation block 120 in rotating the information processing apparatus 100 (or the screen of the display block 603). This processing procedure starts when the rotation of the information processing apparatus 100 main body is detected by the rotation/mount mechanism block 180 or a change in the rotational position of the information processing apparatus 100 main body is detected by the three-axis sensor block 515, for example.

In rotating the information processing apparatus 100 (or the screen of the display block 603), the computation block 120 first obtains the attribute information of video content displayed on the screen (step S4601). Next, the computation block 120 checks whether the video content displayed on the screen is copyright-protected for example (step S4602).

If the video content displayed on the screen is found to be copyright-protected (Yes of step S4602), then the computation block 120 selects a display form in which all areas of the video content are displayed such that the video content is not cut from view as shown in FIG. 42 (step S4603).

If the video content displayed on the screen is found to be not copyright-protected (No of step S4602), then the computation block 120 checks for a display form specified by the user (step S4604).

If the user is selecting the display form in which all areas of video content are displayed, then the procedure goes to step S4603. If the user is selecting the display form in which the focused area is displayed maximum, then the procedure goes to step S4605. If the user is selecting the display form in which no invalid area is displayed, the procedure goes to step S4606. If the user is selecting none of these display forms, then the display form set as default among these three display forms is selected.

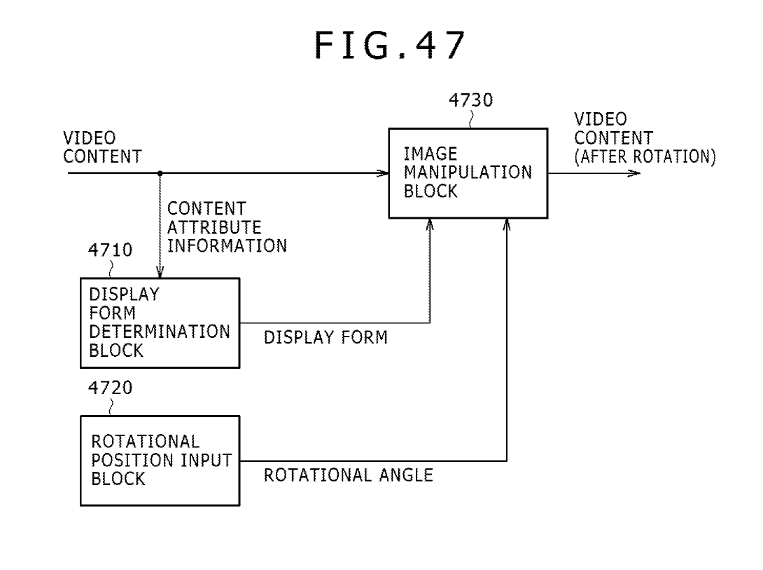

FIG. 47 shows an exemplary internal configuration for the computation block 120 to execute the processing of adjusting a video content display form at a given rotational angle of the information processing apparatus 100 main body or in the transition process of the rotating. The computation block 120 has a display form determination block 4710, a rotational position input block 4720, and an image manipulation block 4730 to adjust the display form of received television broadcast and the video content reproduced from media.

The display form determination block 4710 determines a display form for use in rotating video content at a given rotational angle of the information processing apparatus 100 main body or in the process of rotating, in accordance with the processing procedure shown in FIG. 46.

The rotational position input block 4720 enters, through the input interface integration block 520, a rotational position of the information processing apparatus 100 main body (or the screen of the display block 603) obtained through the rotation/mount mechanism block 180 or the three-axis sensor block 515.

The image manipulation block 4730 executes image manipulation in accordance with the display form determined by the display form determination block 4710 such that the received television broadcast or the video content reproduced from media fits the screen of the display block 603 tilted by a rotational angle entered by the rotational position input block 4720.

### (G) Technology Disclosed Herein

The technology disclosed herein may also take the following configuration:

(101) An information processing apparatus including: a display block; a user detection block configured to detect a user present around the above-mentioned display block; and a computation section configured to process an operated object to be displayed on the above-mentioned display block upon detection of a user by the above-mentioned user detection block.

(102) The information processing apparatus according to (101) above, wherein the above-mentioned user detection block has a proximity sensor arranged on each of four rim sections of a screen of the above-mentioned display block, thereby detecting a user present near each of the four rim sections.

(103) The information processing apparatus according to (101) above, wherein the computation section sets a user occupied area for each detected user and a common area shared by detected users in a screen of the above-mentioned display block in accordance with the arrangement of the users detected by the above-mentioned user detection block.

(104) The information processing apparatus according to (103) above, wherein the above-mentioned computation section displays one or more operated objects to be operated by a user onto the screen of the above-mentioned display block.

(105) The information processing apparatus according to (104) above, wherein the above-mentioned computation section optimizes an operated object in a user occupied area.

(106) The information processing apparatus according to (104), wherein the above-mentioned computation section executes rotational processing such that an operated object in a user occupied area faces a user concerned.

(107) The information processing apparatus according to (104) above, wherein the computation section executes rotational processing such that an operated object moved from a common area or another user occupied area to the user occupied area faces the user concerned.

(108) The information processing apparatus according to (107), wherein, when the user moves an operated object between areas by dragging, the above-mentioned computation section controls a rotational direction in rotating the operated object in accordance with a position at which the user operated the operated object relative to a center-of-gravity position of the operated object.

(109) The information processing apparatus according to (103) above, wherein, when setting a user occupied area of a user newly detected by the user detection block to the screen of the above-mentioned display block, the above-mentioned computation section displays a detection indicator indicative of the new detection of the user.

(110) The information processing apparatus according to (104), further including a data transmission/reception block for transmitting/receiving data to/from a terminal held by the user.

(111) The information processing apparatus according to (110) above, wherein the above-mentioned data transmission/reception block executes data transmission/reception to/from a terminal held by the user detected by the above-mentioned user detection block and the above-mentioned computation section makes an operated object corresponding to data received from the terminal held by the user appear in the user occupied area concerned.

(112) The information processing apparatus according to (104) above, wherein, in accordance with the movement of an operated object between the user occupied areas of the respective users, the above-mentioned computation section copies the operated object onto the user occupied area to which the operated object was moved or divides the operated object.

(113) The information processing apparatus according to (112), wherein the computation section displays a copy of an operated object produced as another data onto the user occupied area to which the operated object was moved.

(114) The information processing apparatus according to (112) above, wherein the above-mentioned computation section displays a copy of an operated object that provides another window of an application that can be collaboratively operated between users onto the user occupied area to which the operated object was moved.

(115) An information processing method including the steps of: detecting a user present around the above-mentioned display block; and processing an operated object to be displayed upon detection of a user in the above-mentioned user detection step.

(116) A computer program written in a computer-readable language to make a computer function as: a display block; a user detection block configured to detect a user present around the above-mentioned display block; and a computation section configured to process an operated object to be displayed on the above-mentioned display block upon detection of a user by the above-mentioned user detection block.

(201) An information processing apparatus including: a display block; a user position detection block configured to detect a user position relative to a screen of the above-mentioned display block; a user state detection block configured to detect a user state relative to the screen of the above-mentioned display block; and a computation section configured to control GUI to be displayed on the above-mentioned display block in accordance with a user position detected by the above-mentioned user position detection block and a user state detected by the above-mentioned user state detection block.

(202) The information processing apparatus according to (201) above, wherein the above-mentioned computation section controls, in accordance with user position and user state, a framework or information density of one or more operated objects to be operated by a user, the framework or information density being displayed on the screen of the above-mentioned display block.

(203) The information processing apparatus according to (201) above, wherein the above-mentioned computation section controls a framework of an operated object to be displayed on the screen in accordance with whether or not the user is viewing a screen of the above-mentioned display block.

(204) The information processing apparatus according to (201) above, wherein the above-mentioned computation section controls information density of an operated object to be displayed on the screen of the above-mentioned display block in accordance with a user position.

(205) The information processing apparatus according to (201) above, wherein the above-mentioned computation section controls the selection of an operated object to be displayed on the screen of the above-mentioned display block in accordance with whether the user is at a position where the user is personally identifiable.

(206) The information processing apparatus according to (201) above, further including: one or more input means through which the user operates an operated object displayed on the screen of the above-mentioned display block, wherein the above-mentioned computation section controls a framework of an operated object to be displayed on the screen in accordance with whether or not the user is operating the operated object through the above-mentioned input means.

(207) An information processing apparatus including: a display block; one or more input means configured for a user to operate an operated object displayed on a screen of the above-mentioned display block; a user position detection block configured to detect a user position relative to the above-mentioned display block; a user state detection block configured to detect a user state relative to the screen of the above-mentioned display block; and a computation section configured to optimize the above-mentioned input means in accordance with a user position detected by the above-mentioned user position detection block and a user state detected by the above-mentioned user state detection block.

(208) The information processing apparatus according to (207) above, wherein the above-mentioned computation section controls the optimization of the above-mentioned input means in accordance with whether or not the user is viewing the screen of the above-mentioned display block.

(209) The information processing apparatus according to (207) above, wherein the above-mentioned computation section optimizes the input means in accordance with whether a user position detected by the above-mentioned user position detection block in a state where the user is viewing the screen of the above-mentioned display block.

(210) An information processing apparatus including: a display block; a user position detection block configured to detect a user position relative to the above-mentioned display block; a plurality of distance detection schemes configured to detect a distance from a screen of the above-mentioned display block to a user; and a computation section configured to control switching between the above-mentioned plurality of distance detection schemes in accordance with a user position detection by the above-mentioned user position detection block.

(211) The information processing apparatus according to (210) above, wherein the above-mentioned computation section always turns on the above-mentioned plurality of distance detection schemes for detecting a distance to a remote user.

(212) The information processing apparatus according to (210) above, wherein the above-mentioned computation section turns on the function of the above-mentioned plurality of distance detection schemes only in a range where a sufficient recognition accuracy is obtained, the above-mentioned plurality of distance detection schemes detecting a distance of a near user and executing recognition processing.

(213) An information processing method including: detecting a user position relative to a display screen; detecting a user state relative to the above-mentioned display screen; and controlling GUI to be displayed on the above-mentioned display screen in accordance with a user position detected in the above-mentioned user detection step and a user state detected in the above-mentioned user state detection step.

(214) An information processing method including: detecting a user position relative to a display screen; detecting a user state relative to the above-mentioned display screen; and optimizing one or more input means for a user to operate an operated object displayed on the above-mentioned display screen in accordance with a user position detected in the above-mentioned user position detection step and a user state detected in the above-mentioned user state detection step.

(215) An information processing method including: detecting a user position relative to a display screen; and controlling switching of a plurality of distance detection schemes for detecting a distance from the above-mentioned display screen to the user in accordance with a user position detected in the above-mentioned user position detection step.

(216) A computer program written in a computer-readable language to make a computer function as: a display block; a user position detection block configured to detect a user position relative to the above-mentioned display block; a user state detection block configured to detect a user state relative to a display screen of the above-mentioned display block; and a computation section configured to control GUI to be displayed on the above-mentioned display block in accordance with a user position detected by the above-mentioned user position detection block and a user state detected by the above-mentioned user state detection block.

(217) A computer program written in a computer-readable language to make a computer function as: a display block; one or more input means configured for a user to operate an operated object displayed on a screen of the above-mentioned display block; a user position detection block configured to detect a user position relative to the above-mentioned display block; a user state detection block configured to detect a user state relative to the screen of the above-mentioned display block; and a computation section configured to optimize the above-mentioned input means in accordance with a user position detected by the above-mentioned user position detection block and a user state detected by the above-mentioned user state detection block.

(218) A computer program written in a computer-readable language to make a computer function as: a display block; a user position detection block configured to detect a user position relative to the above-mentioned display block; a plurality of distance detection schemes configured to detect a distance from a screen of the above-mentioned display block to the user; and a computation section configured to control switching between the above-mentioned plurality of distance detection schemes in accordance with a user position detected by the above-mentioned user position detection block.

(301) An information processing apparatus including: a display block, an object image capture block configured to capture an object image to be displayed on a screen of the above-mentioned display block; a real size capture block configured to capture real size information of the above-mentioned object to be displayed on the screen of the above-mentioned display block; and a computation section configured to process the above-mentioned object image on the basis of a real size of the above-mentioned object captured by the above-mentioned real size capture block.

(302) The information processing apparatus according to (301) above, further including: a display performance capture block configured to capture information associated with display performance including a screen size and a resolution of the above-mentioned display block, wherein, on the basis of the real size of the above-mentioned object captured by the above-mentioned real size capture block and the display performance obtained by the above-mentioned display performance capture block, the above-mentioned computation section processes the above-mentioned object image such that the above-mentioned object image is displayed in real size on the screen of the above-mentioned display block.

(303) The information processing apparatus according to (301) above, wherein, in simultaneously displaying a plurality of object images captured by the above-mentioned object image capture block on the screen of the above-mentioned display block, the above-mentioned computation section processes the above-mentioned plurality of object images such that a size relation between the above-mentioned plurality of object images is correctly displayed.

(304) The information processing apparatus according to (301) above, further including: a camera block; and a real size estimation block configured to estimate a real size of an object included in an image taken with the above-mentioned camera block.

(305) The information processing apparatus according to (301) above, further including: a camera block; an image recognition block configured to recognize a user face included in an image taken with the above-mentioned camera block, thereby capturing face data; a distance detection block configured to detect a distance up to the above-mentioned user; and a real size estimation block configured to estimate a real size of the above-mentioned user face on the basis of the face data of the above-mentioned user and the distance up to the above-mentioned user.

(306) An information processing method including: capturing an object image to be displayed on a screen; capturing real size information of the above-mentioned object to be displayed on the screen; and processing the above-mentioned object image on the basis of a real size of the above-mentioned object captured by the above-mentioned real size capture step.

(307) A computer program written in a computer-readable language to make a computer function as: a display block; an object image capture block configured to capture an object image to be displayed on a screen of the above-mentioned display block; a real size capture block configured to capture real size information of the above-mentioned object to be displayed on the screen of the above-mentioned display block; and a computation section configured to process the above-mentioned object image on the basis of a real size of the above-mentioned object captured by the above-mentioned real size capture block.

(401) An information processing apparatus including: a camera block; a display block; and a computation section configured to normalize a user image taken with the above-mentioned camera block when the above-mentioned user image is to be displayed on a screen of the above-mentioned display block.

(402) The information processing apparatus according to (401) above, further including: an object image capture block configured to capture an object image to be displayed on the above-mentioned screen of the above-mentioned display block; and a parallel and superimposition pattern capture block configured to capture a parallel and superimposition pattern for putting the above-mentioned user image and the above-mentioned object image into one of parallel arrangement and superimposed arrangement on the above-mentioned screen of the above-mentioned display block, wherein the above-mentioned computation section normalizes the above-mentioned user image and the above-mentioned object image such that a size relation between and positions of the above-mentioned user image and the above-mentioned object image become correct, thereby putting the normalized user image and the normalized object image into one of the above-mentioned parallel arrangement and the above-mentioned superimposed arrangement in accordance with the captured parallel and superimposition pattern.

(403) The information processing apparatus according to (402) above, wherein the above-mentioned computation section controls the above-mentioned camera block in order to normalize the above-mentioned user image taken with the above-mentioned camera block.

(404) The information processing apparatus according to (401) above, further including: a user face data capture block configured to capture a user face data taken with the above-mentioned camera block; and a face-in-object data capture block configured to capture face data in an object to be displayed on the above-mentioned screen of the above-mentioned display block, wherein the above-mentioned computation section normalizes the above-mentioned user face data and the above-mentioned face-in-object data such that a size relation between and positions of the above-mentioned user face data and the above-mentioned face-in-object data become correct.

(405) The information processing apparatus according to (404) above, wherein the above-mentioned computation section controls the above-mentioned camera block in order to normalize the above-mentioned user image taken with the above-mentioned camera block.

(406) An information processing method including: capturing an object image to be displayed on a screen of a display block; capturing a parallel and superimposition pattern for putting a user image taken with a camera block and the above-mentioned object image into one of parallel arrangement and superimposed arrangement on the screen of the display block; normalizing the above-mentioned user image and the above-mentioned object image such that a size relation between and positions of the above-mentioned user image and the above-mentioned object image become correct; and putting the normalized user image and the normalized object image into one of parallel arrangement and superimposed arrangement in accordance with the captured parallel and superimposition pattern.

(407) An information processing method including: capturing face data of a user taken with a camera block; capturing face-in-object data to be displayed on a screen; and normalizing the above-mentioned user face data and the above-mentioned face-in-object data such that a size relation between and positions of the above-mentioned user face data and the above-mentioned face-in-object data become correct.

(408) A computer program written in a computer-readable language, the program causing a computer to function as: a camera block; a display block; and a computation section configured to normalize a user image taken with the above-mentioned camera block when the above-mentioned user image is to be displayed on a screen of the above-mentioned display block.

(501) An information processing apparatus including: a display block configured to display video content on a screen; a rotational angle detection block configured to detect a rotational angle of the above-mentioned screen; a display form determination block configured to determine a video content display form at a given rotational angle of the above-mentioned screen and in the transition process of rotating; and an image manipulation block configured to execute image manipulation such that video content fits the above-mentioned screen tilting by the rotational angle detected by the above-mentioned rotational angle detection block in accordance with the display form determined by the above-mentioned display form determination block.

(502) The information processing apparatus according to (501) above, wherein the above-mentioned display form determination block determines one of three display forms; a display form in which video content is not cut from view at a given rotational angle, a display form in which a focused portion of video content is maximized in size at each rotational angle, and a display form in which video content is rotated such that there occurs no invalid area.

(503) The information processing apparatus according to (501) above, wherein the above-mentioned display form determination block determines a display form at a given rotational angle of the above-mentioned screen and in the transition process of rotating on the basis of attribute information of video content.

(504) The information processing apparatus according to (501), wherein the above-mentioned display form determination block determines a display form such that entire copyright-protected video content is not cut from view at a given rotational angle.

(505) An information processing method including: detecting a rotational angle of a screen on which video content is displayed; determining a video content display form at a given rotational angle of the above-mentioned screen and in the transition process of rotating; and executing image manipulation such that video content fits the above-mentioned screen tilting by the rotational angle detected in the above-mentioned rotational angle detection step in accordance with the display form determined in the above-mentioned display form determination step.

(506) A computer program written in a computer-readable language to make a computer function as: a display block configured to display video content on a screen; a rotational angle detection block configured to detect a rotational angle of the above-mentioned screen; a display form determination block configured to determine a video content display form at a given rotational angle of the above-mentioned screen and in the transition process of rotating; and an image manipulation block configured to execute image manipulation such that video content fits the above-mentioned screen tilting by the rotational angle detected by the above-mentioned rotational angle detection block in accordance with the display form determined by the above-mentioned display form determination block.

While preferred embodiments of the present invention have been described using specific terms, such description is for illustrative purpose only, and it is to be understood that changes and variations may be made without departing from the spirit or scope of the following claims.

Herein, embodiments assuming a television receiver having a large-size screen as the information processing apparatus 100 based on the technology disclosed herein have been described so far; however the gist of the technology disclosed herein is not limited thereto. The technology disclosed herein is also applicable to such information processing apparatuses other than television receivers as a personal computer and a tablet terminal and to information processing apparatuses having screen sizes not large.

In other words, the technology disclosed herein has been described as illustrative only and therefore the description hereof should not be interpreted restrictively. In order to judge the gist of the technology disclosed herein, the scope of claims herein should be taken into consideration.

The present technology contains subject matter related to that disclosed in Japanese Priority Patent Application JP 2012-005504 filed in the Japan Patent Office on Jan. 13, 2012, the entire content of which is hereby incorporated by reference.

1. An information processing apparatus comprising:
a camera block;
a display block; and
a computation section configured to normalize a user image taken with said camera block when said user image is to be displayed on a screen of said display block.

2. The information processing apparatus according to claim 1, further comprising:
an object image capture block configured to capture an object image to be displayed on said screen of said display block; and
a parallel and superimposition pattern capture block configured to capture a parallel and superimposition pattern for putting said user image and said object image into one of parallel arrangement and superimposed arrangement on said screen of said display block,
wherein said computation section normalizes said user image and said object image such that a size relation between and positions of said user image and said object image become correct, thereby putting the normalized user image and the normalized object image into one of said parallel arrangement and said superimposed arrangement in accordance with the captured parallel and superimposition pattern.

3. The information processing apparatus according to claim 2, wherein said computation section controls said camera block in order to normalize said user image taken with said camera block.

4. The information processing apparatus according to claim 1, further comprising:
a user face data capture block configured to capture a user face data taken with said camera block; and
a face-in-object data capture block configured to capture face data in an object to be displayed on said screen of said display block,
wherein said computation section normalizes said user face data and said face-in-object data such that a size relation between and positions of said user face data and said face-in-object data become correct.

5. The information processing apparatus according to claim 4, wherein said computation section controls said camera block in order to normalize said user image taken with said camera block.

6. An information processing method comprising:
capturing an object image to be displayed on a screen of a display block;
capturing a parallel and superimposition pattern for putting a user image taken with a camera block and said object image into one of parallel arrangement and superimposed arrangement on the screen of the display block;
normalizing said user image and said object image such that a size relation between and positions of said user image and said object image become correct; and
putting the normalized user image and the normalized object image into one of parallel arrangement and superimposed arrangement in accordance with the captured parallel and superimposition pattern.

7. An information processing method comprising:
capturing face data of a user taken with a camera block;
capturing face-in-object data to be displayed on a screen; and
normalizing said user face data and said face-in-object data such that a size relation between and positions of said user face data and said face-in-object data become correct.

8. A computer program written in a computer-readable language to make a computer function as:
a camera block;
a display block; and
a computation section configured to normalize a user image taken with said camera block when said user image is to be displayed on a screen of said display block.
